(19) United States
(12) Patent Application Publication
(10) Pub. No.: US 2026/0003590 A1
(43) Pub. Date: Jan. 1, 2026

(54) System and Method for Optimizing Machine Learning Inference Systems and Processes for Operating A Compiler Therefor

(71) Applicant: CentML AI Inc., Toronto (CA)

(72) Inventors: Xiao ZHANG, Toronto (CA); Yaoyao DING, Toronto (CA); Yang HU, Toronto (CA); Gennady PEKHIMENKO, Toronto (CA)

(73) Assignee: CentML AI Inc., Toronto (CA)

(21) Appl. No.: 19/252,858

(22) Filed: Jun. 27, 2025

Related U.S. Application Data
(60) Provisional application No. 63/664,812, filed on Jun. 27, 2024.

(51) Int. Cl. G06F 8/41

(52) U.S. Cl. CPC G06F 8/443

(57) ABSTRACT

A computer system is provided for compiling computer programs using machine learning compilers. The method includes obtaining a first computer program written in a script with a defined programming language dialect for a particular machine learning compiler, defining a higher level intermediate representation (IR) that represents the first computer program written with the defined programming language dialect; generating a second computer program represented in the higher level IR; deriving a plurality of new optimization passes based on the higher level IR; converting the second computer program represented in the higher level IR into a third computer program represented in one or more lower-level IRs that exist in the machine learning compiler; applying a plurality of existing optimization passes to generate an optimized fourth computer program represented in the existing lower-level IR; and converting the optimized fourth computer program represented in the existing lower-level IR-to-machine instructions.

### CROSS-REFERENCE TO RELATE APPLICATION(S)

This application claims priority to U.S. Provisional Patent Application No. 63/664,812 filed on Jun. 27, 2024, the contents of which are incorporated herein by reference in their entirety.

### TECHNICAL FIELD

The following generally relates to machine learning inference systems and, in particular, to systems and methods for optimizing such inference systems, for example by optimizing a compiler therefor.

### BACKGROUND

Deep learning (DL) has demonstrated remarkable power across various applications, including image recognition [12], natural language processing [32], and autonomous driving [41]. Recently, large language models (LLMs) [1] have shown astonishing generalization capabilities, elevating the influence of DL to unprecedented levels. Deep neural networks (DNNs) are composed of tensor algebra operations, and both training and deployment require enormous computational and memory resources. To speed up these workloads, most DNNs run on accelerators, such as TPUs [16], GPUs [15], and NPUs [20]. Among these, GPUs are the most accessible accelerators for both research and industry use.

Programming efficient GPU programs is challenging due to the complex architectures and execution models of modern GPUs. GPUs consist of streaming multiprocessors (SMs) on NVIDIA® devices or compute units (CUs) on AMD devices, both of which employ the Single Instruction Multiple Threads (SIMT) model [22]. Their memory hierarchy includes global memory (DRAM), a shared L2 cache, per-SM programmable L1 caches (shared memory), and fast register memory managed by threads. Memory access requires specific optimizations: global memory must be coalesced [4], and shared memory accesses must avoid bank conflicts [33]. Modern GPUs also integrate specialized units, such as NVIDIA's Tensor Cores or AMD's Matrix Cores, to accelerate deep learning. These units reshape the programming model by executing instructions collectively within thread groups (warps or wavefronts) rather than individually, complicating tensor programming by requiring coordinated thread behavior.

Various DL compilers [7, 40, 42, 44] are proposed to address the complexity of optimizing tensor programs. Most rely on loop transformations [2] to optimize tensor computations but struggle to express key techniques for Tensor Cores, such as software pipelining for latency hiding. To overcome this limitation, Hidet [6]proposes a task-mapping programming paradigm to express these fine-grained optimizations. It converts the scheduling of a GPU program into a problem of finding the optimal task mappings and efficient memory layouts. However, task mappings and layouts need to be manually specified, which demands intimate knowledge of GPU architecture and considerable engineering effort. Furthermore, specifying task mappings is error-prone due to the interdependency of different task mappings, and inconsistent task mappings can cause the program to function improperly. Similarly, Graphene [11] adopts an approach that leverages a concept called Layout to represent task mappings.

Weight-only quantization [9, 18] for LLMs intensifies the complexity of tensor programming. While quantization compresses weights and accelerates computation, it introduces a new kind of matrix multiplication with mixed input types. Manually implementing these operators is challenging due to the proliferation of low-precision data types. In addition, existing compilers provide limited support for low-precision computations. For example, Triton [31] has been found to struggle to deliver decent performance because its layout system cannot express the hardware-friendly shared memory layouts required for low-precision data types and lacks hardware abstractions, such as shared memory and register, to implement fine-grained data pipelines for these operators. Ladder [35] extends TVM with new primitives to support low-precision computation. However, TVM's loop-oriented transformations make it challenging to express these key techniques, often resulting in suboptimal performance.

### SUMMARY

To address the above challenges, the present disclosure proposes to conduct a comprehensive benchmark of several existing frameworks for LLM serving, providing insights into the application characteristics at both the framework and GPU kernel levels. Through detailed breakdown analysis, one can identify the bottlenecks in LLM and other machine learning inference and explore optimization opportunities for these workloads, including efficient mixed-type GEMM implementations and new primitives that readily express these optimizations in machine learning compilers.

In one aspect, there is provided a method of compiling computer programs using machine learning compilers, the method comprising: obtaining a first computer program written in a script with a defined programming language dialect for a particular machine learning compiler, the dialect representing computer programs of mathematical operations in machine learning applications; defining a higher level intermediate representation (IR) that represents the first computer program written with the defined programming language dialect; generating a second computer program represented in the higher level IR from the first computer program written in the defined programming language dialect; deriving a plurality of new optimization passes based on the higher level IR that, when applied, the particular machine learning compiler optimizes the performance of executing computer programs in a target computing environment; converting the second computer program represented in the higher level IR into a third computer program represented in one or more lower-level IRs that exist in the machine learning compiler; applying a plurality of existing optimization passes to generate an optimized fourth computer program represented in the existing lower-level IR for the particular machine learning compiler; and converting the optimized fourth computer program represented in the existing lower-level IR-to-machine instructions to be used in a machine learning application.

In example embodiments, the plurality of new optimization passes comprises instantiating an auto annotation operation.

In example embodiments, the plurality of new optimization passes comprises an instruction selection step.

In example embodiments, the plurality of new optimization passes comprises a bank conflict elimination operation.

In example embodiments, the plurality of new optimization passes comprises lowering a program represented in the higher level IR to generate the third computer program in the one or more lower level IRs existing in the machine learning compiler.

In example embodiments, the machine learning compiler is a Hidet compiler and the plurality of existing optimization passes comprise optimization passes existing in the Hidet compiler.

In example embodiments, the method further includes providing the machine instructions to the machine learning application for execution.

In example embodiments, the defined programming language dialect is the Hexcute dialect.

In example embodiments, the mathematical operations in machine learning applications comprise matrix multiplication, convolution, attention, activation functions, normalization, and/or pooling.

In other aspects, computing devices and computer readable medium storing computer executable instructions for implementing the method are provided.

### BRIEF DESCRIPTION OF THE DRAWINGS

Embodiments will now be described with reference to the appended drawings wherein:

FIG. 1 is an example of a computing environment comprising a compiler.

FIG. 2 is a block diagram illustrating an example configuration for a computing device that may be utilized in the computing environment.

FIG. 3 is a flow chart illustrating a compilation overview.

FIG. 4 illustrates a FP16×INT4 matmul written with Triton, where activation matrix A is of the float16 data type and weight matrix B includes 4-bit integers.

FIG. 5 illustrates the dataflow of mixed-type matmul kernels.

FIG. 6 illustrates the INT4 packed layout designed in TensorRTLLM ensures layout conformance when converting INT4 weights to F16 weights.

FIG. 7(a) illustrates thread block of 128 threads copies a 64×8 tile from shared memory to register files, with the cooperative_load function implemented with task mapping constructs.

FIG. 7(b) illustrates thread block of 128 threads copies a 64×8 tile from shared memory to register files, illustrating how task mapping defines the collective data movement.

FIG. 8 provides an example of row-major interleaved layout A, with part (a) visualizing the function defined by A, with the integers in the box indicating the function's outputs.

FIG. 9 illustrates an example of a thread-value layout B.

FIG. 10 provides an example of a GEMM kernel written with Hidet.

FIG. 11(a) illustrates a simple GEMM kernel written with Hexcute.

FIG. 11(b) illustrates a build with thread-value layout constraints.

FIG. 11(c) illustrates task-mapping and layout sytheses.

FIG. 11(d) illustrates instruction selection and code generation.

FIG. 12 illustrates how to create tensors in shared memory.

FIG. 13(a) shows an Idmatrix instruction for thread-value layouts to specify semantics of the memory and compute instructions on modern GPUs.

FIG. 13(b) shows an mma instruction for thread-value layouts to specify semantics of the memory and compute instructions on modern GPUs.

FIG. 14 illustrates the composite function g∘q⁻¹.

FIG. 15 shows the thread-value layout constraints for copy, mma, elementwise, and reduce operations.

FIG. 16 provides an example of two matmuls with a reduce in between.

FIG. 17 illustrates Algorithm 1, a thread-value layout synthesis algorithm.

FIG. 18 provides an example of shared memory synthesis.

FIG. 19 illustrates a generic swizzle function.

FIG. 20 illustrates operator comparison to existing compilers and hand-written kernel libraries on the RTX4090 GPU.

FIG. 21 shows a performance comparison of an FP16×INT4 matmul kernel on RTX4090.

FIG. 22 shows a performance comparison of Hexcute, Triton, and Marlin of an MoE layer with 256 experts on H100.

FIG. 23 illustrates integrating Hexcute-generated MoE kernels into vLLM brings up to 2.91× speedup to the best existing system.

FIG. 24 provides a graph showing results of an ablation study on the A100 GPU.

FIG. 25 provides syntax of the tile-level operators in Hexcute.

FIG. 26(a) shows that the composite mapping function ƒ_{A}∘p_{A}⁻¹ maps the four matrices from the instruction tile A to distinct positions in tensor A.

FIG. 26(b) illustrates that ƒ_{C}∘p_{C}⁻¹ maps the two matrices in the instruction tile C to different positions in tensor C.

FIG. 27 shows the thread-value constraints for matrices A, B, and C in the mma operation represented using commutative diagrams.

FIG. 28 provides examples of shared memory layout constraints.

### DETAILED DESCRIPTION

DL workloads mainly run on accelerators like GPUs. Recent DL quantization techniques demand a new matrix multiplication operator with mixed input data types, further complicating GPU optimization. Prior high-level compilers like Triton lack the expressiveness to implement key optimizations like fine-grained data pipelines and hardware friendly memory layouts for these operators, while low-level programming models, such as Hidet, Graphene, and CUTLASS, require significant programming efforts. To balance expressiveness with engineering effort, the following describes a tile-based programming language that exposes shared memory and register abstractions to enable fine-grained optimization for these operators, hereinafter also referred to as “Hexcute” for brevity. Additionally, Hexcute leverages task mapping to schedule the GPU program, and to reduce programming efforts, it automates layout and task mapping synthesis with a novel type-inference-based algorithm.

To express the key optimizations for mixed-type operators and reduce the programming efforts of fine-grained programming models like Hidet [6] and Graphene [11], Hexcute proposes a tile-based programming language with shared memory and register abstractions. This allows one to express the efficient data pipeline for low-precision computations. The system can leverage task mappings [6] to schedule GPU programs. To remove the need for manual task mapping specifications, a novel type system is proposed for automatically synthesizing task mappings and layouts of register and shared tensors. In our design, the data distribution across threads is considered part of the tensor types. Then, one may build constraints for these types and design a type-inference-based [10] algorithm to synthesize task mappings and layouts. This technique obtains the correctness and performance of generated code. The proposed tile-based programming language, called Hexcute, is implemented to optimize a wide range of operators in DL training and inference, including mixed-type operations. One can integrate Hexcute into vLLM [17] and demonstrate superior performance compared to existing state-of-the-art hand-written and compiler-generated kernels.

The following is provided:
A new tile-based programming language that exposes shared memory and registers abstraction, allowing one to express fine-grained optimizations for low-precision computations.
Consider the data distribution across threads as part of tensor types. By building constraints on tensor types for each tile-level operation, formalize the task mapping and layout synthesis problem as a constraint programming problem. Then, design a type-inference-based algorithm to automatically synthesize them, which achieves the correctness and performance of the generated GPU program.
Implement Hexcute with the above ideas and integrate it into vLLM [17]. An evaluation demonstrates that Hexcute generalizes to a wide range of DL operators, achieves 1.7-11.28× speedup over existing state-of-the-art DL compilers for mixed-type operators, and brings up to 2.9× in the end-to-end evaluation.

### 1. Computing Environment

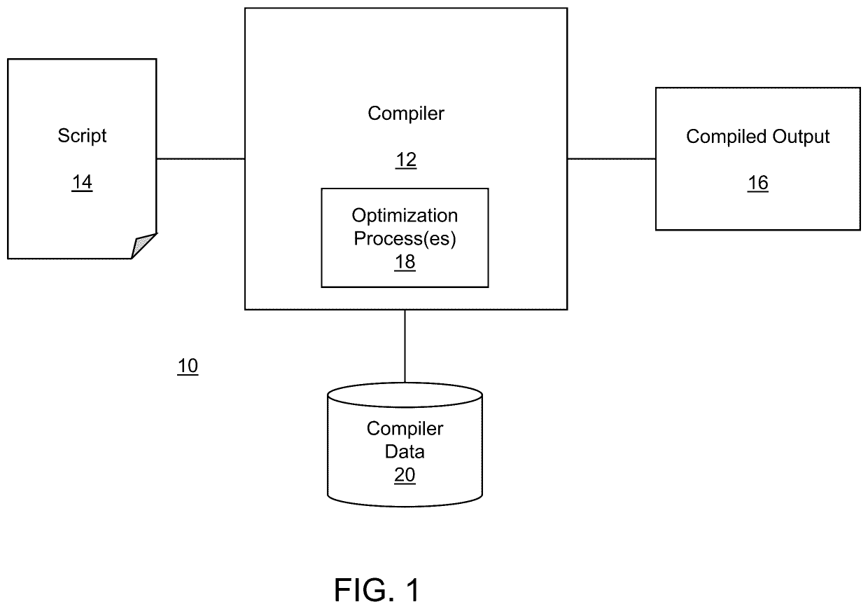

Referring now to FIG. 1, an example of a computing environment 10 is shown in which the present methods, processes and optimizations may be deployed. The computing environment 10 includes a compiler 12, which takes a script 14 written in a suitable programming language as an input and, among other things, integrates at least one optimization process 18 to optimize a compiler activity, step or operation (or multiple ones thereof) in generating a compiled output 16. The compiler 12 also includes or otherwise has access to compiler data 20. The data 20 may include information, constraints, parameters, etc., as discussed herein, which may be machine specific, application specific, user/programmer specific, etc.

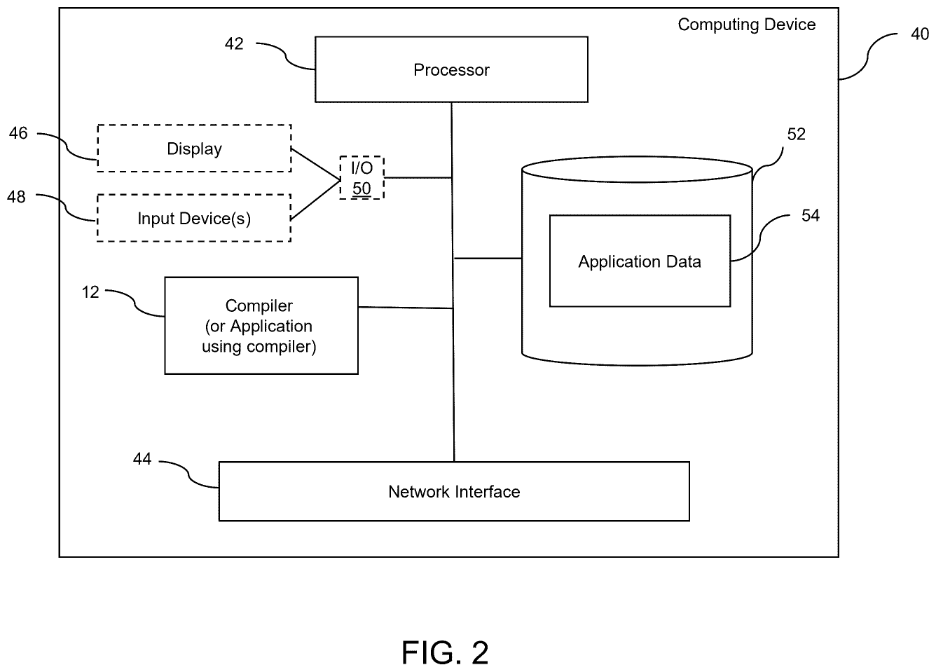

It can be appreciated that the compiler 12 may be running on one or more computing devices 40 (e.g., see FIG. 2). Such computing devices 40 (or computing systems) may include, but are not limited to, a personal (e.g., desktop) computer, a server computer or other computing system that is equally or more powerful or otherwise suitably adapted to compiling computer code, e.g., for use with machine learning and/or other applications, such as LLMs. Such computing devices 40 may also, where applicable, include a mobile phone, a laptop computer, a tablet computer, a notebook computer, a hand-held computer, a personal digital assistant, a portable navigation device, a wearable device, a gaming device, an embedded device, edge device, a virtual reality device, an augmented reality device, etc.

The compiler 12 may be hosted or otherwise run on the one or more computing devices 40 or may be accessed by the computing device(s) 40 over a communication network (not shown). Such communication network(s) may include the Internet, accessed via, for example, a telephone network, cellular, and/or data communication network to connect different types of client- and/or server-type devices. For example, the communication network may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet). The compiler 12 may be embodied in an application, which may take the form of a mobile-type application (also referred to as an “app”), a desktop-type application, an embedded application in customized computing systems, or an instance or page contained and provided within a web/Internet browser, to name a few.

The script 14 may be provided by a separate one or more computing devices 40 or computing system, by a separate entity or may be integrated with a system or application running the compiler 12 within the same computing device(s) 40 or computing system. As such, the configuration shown in FIG. 1 is illustrative and other computing device/system configurations are possible. For example, the computing environment 10 shown in FIG. 1 may represent a single device such as a portable electronic device or the integration/cooperation of multiple electronic devices such as a client device and server device or a client device and a remote or offsite storage or processing entity or service or multiple client or server devices working together in a compiling or other programming jobs using more than one computing device (e.g., utilizing or generating code for graphic processing units (GPUs)). That is, the computing environment 10 may be implemented using any one or more electronic devices including standalone devices and those connected to offsite storage and processing operations (e.g., via cloud-based computing storage and processing facilities).

FIG. 2 shows an example of one such computing device 40, e.g., from a set of one or more computing devices 40, which may be utilized by any one or more of the entities shown in FIG. 1, for example, a personal electronic device or server used to provide the compiler 12 or other computing device 40 used to communicate with a device generating and/or providing the script 14. The computing device 40 in FIG. 2 may, additionally or alternatively, provide an example of a device on which the compiled output 16 may be deployed or accessed. Similarly, the computing device 40 in FIG. 2 may provide an example of a device on which downstream application(s)—not shown, may be deployed.

In this example, the computing device 40 includes one or more processors 42 (e.g., a microprocessor, microcontroller, embedded processor, digital signal processor (DSP), central processing unit (CPU), media processor, graphics processing unit (GPU) or other hardware-based processing units) and one or more network interfaces 44 (e.g., a wired or wireless transceiver device connectable to a network via a communication connection).

Examples of such communication connections can include wired connections such as twisted pair, coaxial, Ethernet, fiber optic, etc. and/or wireless connections such as LAN, WAN, PAN and/or via short-range communications protocols such as Bluetooth, WiFi, NFC, IR, etc.

The computing device(s) 40 may also include the compiler 12 (or other application(s)), a data store 52, and client application data 54. The data store 52 may represent a database or library or other computer-readable medium configured to store data and permit retrieval of data by the computing device 40. The data store 52 may be read-only or may permit modifications to the data. The data store 52 may also store both read-only and write accessible data in the same memory allocation. In this example, the data store 52 stores the application data 54 for the compiler 12 (and/or an application—e.g., some or all of the compiler data 20) that is configured to be executed by the computing device 40 for a particular role or purpose.

While not delineated in FIG. 2, the computing device(s) 40 include(s) at least one memory or memory device that can include a tangible and non-transitory computer-readable medium having stored therein computer programs, sets of instructions, code, or data to be executed by processor(s) 42. The processor(s) 42 and network interface(s) 44 are connected to each other via a data bus or other communication backbone to enable components of the computing device 40 to operate together as described herein. FIG. 2 illustrates examples of modules and applications stored in memory on the computing device 40 and executed by the processor(s) 42.

It can be appreciated that any of the modules and applications shown in FIG. 2 may be hosted externally and may be available to the computing device 40, e.g., via a network interface 44. The data store 52 in this example stores, among other things, the application data 54 that can be accessed and utilized by an application (and/or the compiler 12). The data store 52 may additionally store one or more software functions or routines in a cache or in other types of memory.

As shown in FIG. 2, the computing device(s) 40 may, optionally (e.g., when configured as a personal electronic device such as a smartphone or tablet), include a display 46 and one or more input device(s) 48 that may be utilized via an input/output (I/O) module 50. That is, such components may be omitted when the computing device 40 does not interact with a user.

While examples referred to herein may refer to a single display 46 for ease of illustration, the principles discussed herein may also be applied to multiple displays 46, e.g., to view portions of UIs rendered by or with an application on separate side-by-side screens. That is, any reference to a display 46 may include any one or more displays 46 or screens providing similar visual functions. The application receives one or more inputs from one or more input devices 48, which may include or incorporate inputs made via the display 46 as well as any other available input to the computing environment 10 (e.g., via the I/O module 50), such as haptic or touch gestures, voice commands, eye tracking, biometrics, keyboard or button presses, etc. Such inputs may be applied by a user interacting with the computing environment 10, e.g., by operating the computing device 40.

### 1.3 System Overview

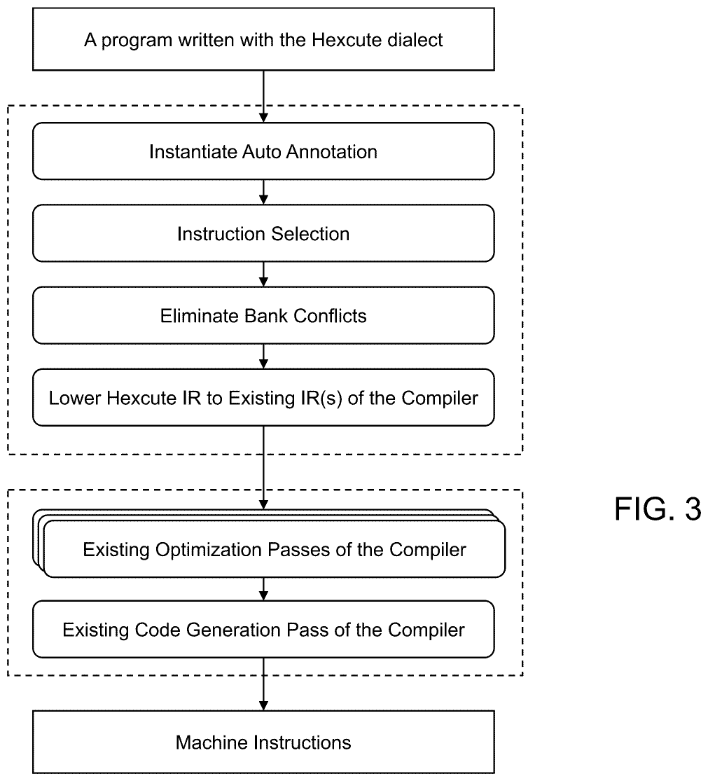

In subsequent sections, the disclosure discusses the compilation process of Hexcute. Specifically, Hexcute initially translates the tile-level program to Hidet IR via a series of optimization passes. Following this, additional built-in optimization passes are applied to the IR. Finally, the optimized Hidet IR is converted to a CUDA C program, which is further converted to machine instructions. FIG. 3 illustrates the entire compilation workflow. As shown in FIG. 3, the process begins with a program written with the Hexcute dialect and enters a first stage of new optimization passes. An optimization pass, such as Shared Memory Usage Update, would convert it into the same high-level IR but a different content In the first stage, the system instantiates auto annotation then moves to instruction selection, eliminates bank conflicts, and then to lower Hexcute IR to existing IR(s) of the compiler as the set of new optimization passes. In a second stage, the output from the first stage undergoes existing optimization passes of the compiler (e.g., optimization passes for Hidet IR) before an existing code generation pass of the compiler. The output from the second stage provides machine instructions for the subsequent application.

### 2. Background and Motivation

### 2.1 Motivational Example: Mixed-Type Operation

Tensor Core instructions on modern GPUs have dramatically accelerated deep learning and reshaped the SIMT programming model [21]. Instead of uniform thread execution, multiple threads now work together on computations and data transfers, complicating GPU programming. Additionally, computational capacity has surged far faster than memory bandwidth. This imbalance demands sophisticated pipelining of data movement across memory hierarchies to hide latency [14, 38]. Recent weight-only quantization techniques for LLMs further complicate tensor programming on GPUs. They introduce a new operator called mixed-type matmul, where weight and activation matrices use different data types. Manually supporting these new operations is becoming unsustainable due to the explosive combinations of data types and quantization schemes [5, 9, 18, 19, 28, 34, 36, 37].

### 2.2 High-Level Programming Models without Sufficient Expressiveness

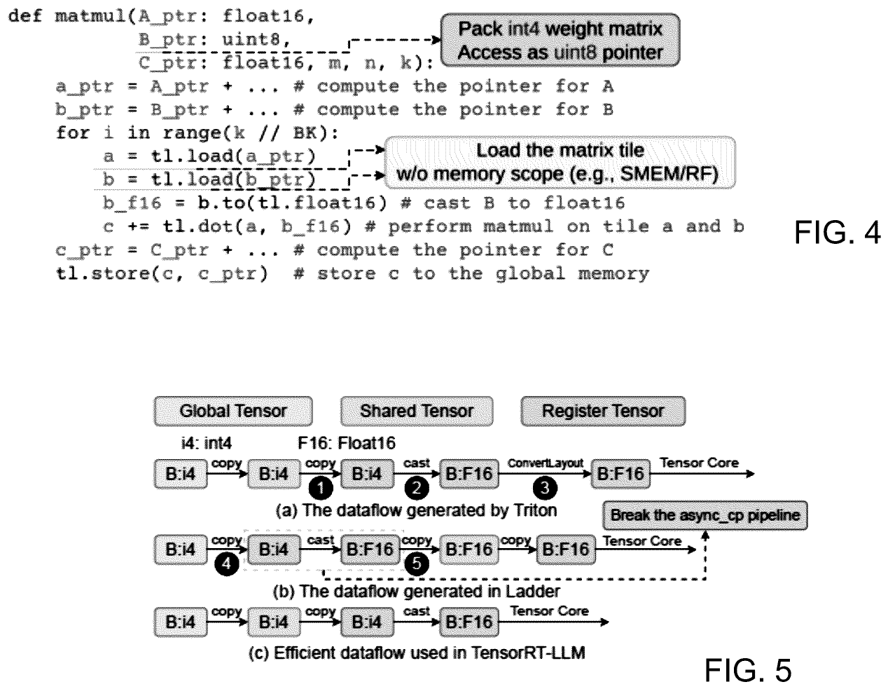

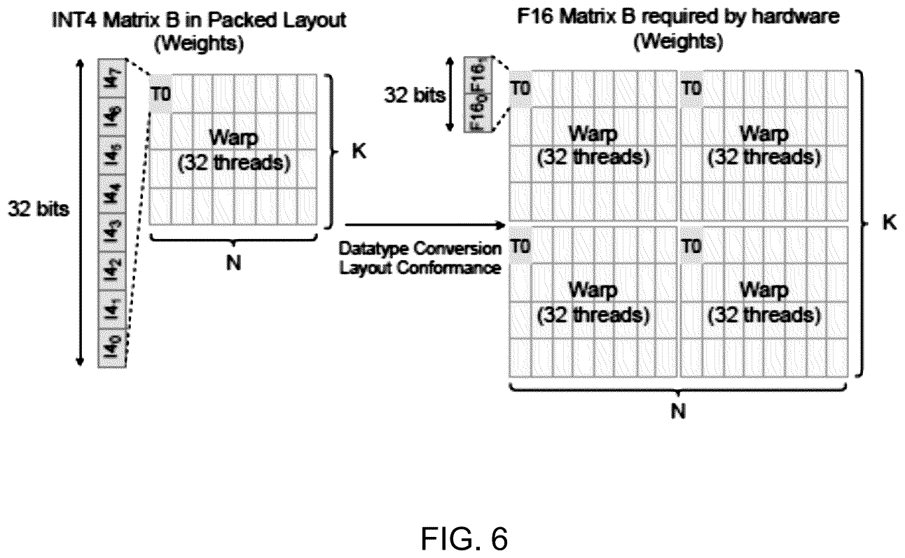

The challenge in mixed-type matmuls is expressing fine-grained software pipelining and hardware-friendly memory layouts. Existing compilers such as Triton [31] and Ladder [35] fail to address the challenge. Triton [31] is a high-level programming model that defines the behavior of an entire thread block and works on tiles instead of scalars. FIG. 4 shows a FP16×INT4 matmul written in Triton. Triton-generated code is inefficient because it inserts a ConvertLayout operation (3) before feeding data to Tensor Core units, as shown in FIG. 5(a). This extra step exchanges register data through shared memory and forces synchronization within the thread block, degrading performance. Triton inserts (3) after the type casting (2) because Tensor Core dictates its inputs to be distributed across threads in a specific manner, while the INT4 weights loaded from (1) do not meet this requirement. FIG. 5(b) shows the dataflow in Ladder, where the weight matrix is dequantized during its transfer from global to shared memory (from (4) to (5)). The dataflow is also suboptimal because it breaks the asynchronous copy pipeline. FIG. 5(c) illustrates the efficient dataflow in TensorRT-LLM [25]. TensorRT-LLM designs a packed layout shown in FIG. 6 that ensures layout conformity when converting the data type. As a result, the dataflow avoids adding extra layout conversion or breaking the asynchronous pipeline. Triton and Ladder generate inefficient pipelines because their layout systems lack the flexibility to express the packed layout and select suboptimal layouts with extra overheads. In addition, Triton does not expose hardware hierarchies like shared memory and register, which also hinders developers from expressing the dataflow explicitly. This limitation becomes severe in complex workloads like mixture-of-experts (MoE) layers [29] on Hopper architecture, where our evaluation shows Triton's approach incurs up to 10× higher latency increase. These shortcomings highlight the need for a more expressive programming model.

### 2.3 Programming Models with Fine-Grained Control

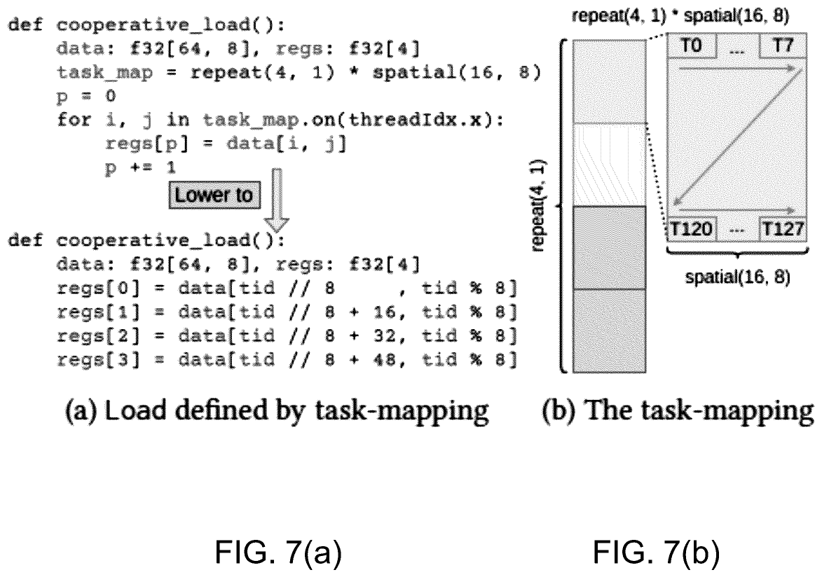

Task Mapping. To express increasingly complex GPU optimizations, Hidet [6] introduces the task-mapping programming model, allowing users to define computational tasks via mapping functions. This model conceptualizes a GPU program as a sequence of thread-block-level operations, each specified by a task mapping. For example, FIG. 7(a) illustrates a cooperative_load function defined with constructs such as repeat and spatial. The task mapping converts thread indices to the task items processed by each thread, as displayed in the generated code at the bottom of FIG. 7(a). Other works, such as Graphene [11], take a similar approach to optimizing tensor programs by leveraging a concept of Layout. This concept is also used in CuTe [24], a C++ tensor algebra library, to design sophisticated mappings.

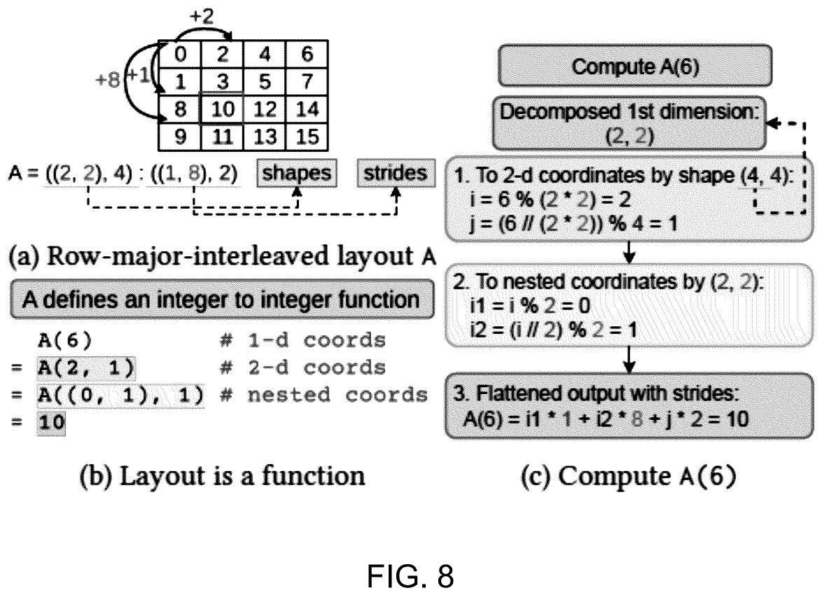

Layout. Layouts like row-major and column-major usually define tensor storage in memory with two tuples: shape, specifying tensor dimensions, and strides, mapping tensor coordinates to memory addresses. CuTe generalizes the layout as a function mapping integers to integers and introduces hierarchical layouts for more complex representations. For instance, FIG. 8, part (a) illustrates a row-major-interleaved layout, A, that splits the row axis of a row-major layout into two sub-dimensions with different strides. This flexibility allows expressing the packed layout in FIG. 6 as ((2,2,2,4),(8,)):((1,8,128,2),(16,)). Layout accepts various input forms (e.g., one-dimensional, two-dimensional, or nested coordinates) and produces the same integer output as shown in FIG. 8, part (b). FIG. 8, part (c) illustrates the computation of A(6), where a one-dimensional coordinate is decomposed into multi-dimensional coordinates and then combined with strides via a dot product to compute the final output.

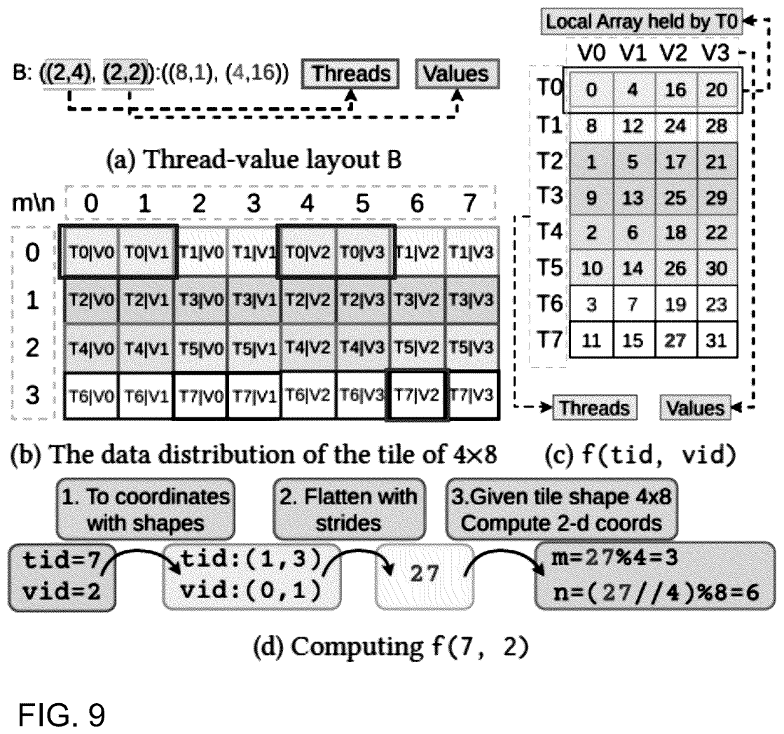

Thread-Value Layout. CuTe introduces the thread-value Layout (TV layout), which determines how data in a tile is distributed across threads. A TV layout is defined as a function: ƒ:(tid, vid) [symbol] flattened_position, where tid is the thread ID and vid is the index of a value within the thread's local array. For example, FIG. 9, part (a) shows a TV layout B mapping eight threads, with each holding four values, to a 4×8 tile. FIG. 9, part (b) visualizes the data distribution of the tile with annotated thread and value IDs. FIG. 9, part (c) illustrates the function defined by B, where the numbers in the boxes represent the function's outputs, i.e., the column-major flattened indices within the tile. Finally, FIG. 9, part (d) demonstrates evaluating ƒ(7, 2): thread 7's second register corresponds to flattened position 27 in the tile, which is then converted to two-dimensional coordinates based on the tile shape. The TV layout, which defines the relationship between threads and their processed tasks, is functionally equivalent to task mapping.

LayoutAlgebra. CuTe treats layouts as mathematical functions, enabling algebraic operations like composition and inversion. Composition R=A∘B is defined as R(c)=A(B(c)), where c is a coordinate in B's domain. A layout A is invertible if there exists a layout A−1 such that A−1 (A(c))=c. For non-invertible layouts, one can define left and right inverses, L and R, which satisfy (L∘A) (c₁)=c₁ and (A∘R) (c₂)=c₂ for coordinates c₁ and c₂ in the corresponding domains.

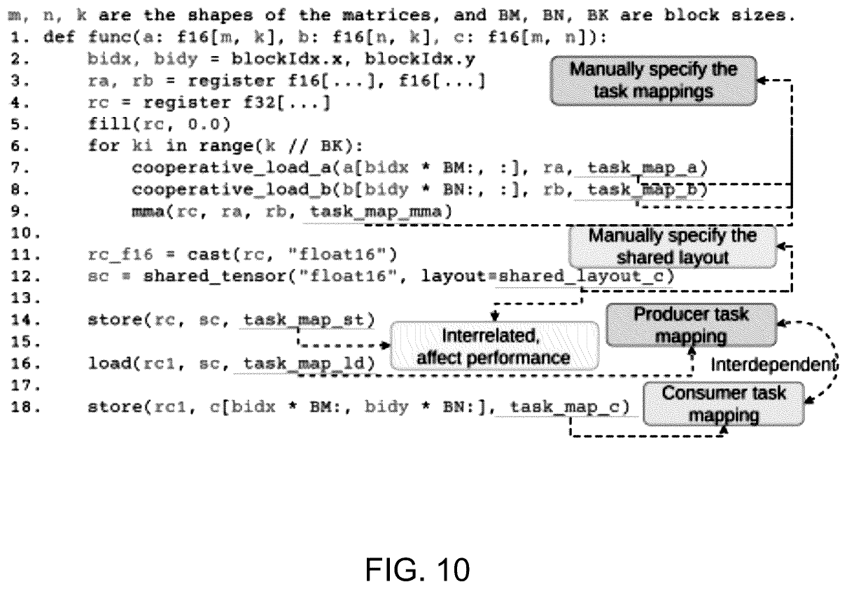

Limitation. Despite the expressiveness, works like Hidet [6], Graphene [11], and CuTe [30], lack an automated mechanism for synthesizing layouts and task mappings. Programmers need to manually specify these for each operation, which is error-prone and inefficient. For instance, FIG. 10 illustrates a complete program written with the task-mapping programming model, where users manually define the task mapping for each block-level operation (e.g., Lines 7-9) and the shared memory layout (e.g., Line 12). Task mappings can be interdependent due to the operation producer-consumer relationship. For example, the store operation (Line 18) consumes data from the load operation (Line 16). The inconsistency of these two operations can lead to incorrect code. Additionally, the task mapping (Line 12) and the shared memory layout (Line 14) are interrelated and affect the performance together. Inefficient mappings and layouts can cause bank conflicts in shared memory accesses, degrading performance.

### 3. System Overview

### 3.1 Key Features

To bridge the gap between high-level programming models like Triton [31] and low-level programming models such as Hidet [6], Graphene [11], and CUTLASS [30], the following proposes a new tile-based programming language called Hexcute. Similar to Triton [31], Hexcute is based on Python and extends Hidet [6] with tile-level primitives. Hexcute exposes hardware hierarchies, such as shared memory and registers, for explicit fine-grained pipeline orchestration. To reduce the verbosity and error-proneness of low-level programming models, Hexcute automates layout and task mapping synthesis using a type-inference-based algorithm. Hexcute treats data distribution across threads as part of tensor types and represents them with thread-value layouts. Hexcute then constructs type relations (constraints) of layouts through algebraic operations (Section 4), which forms a constraint programming problem. Hexcute solves the constraint system through a type-inference-based algorithm in Section 5. After inferring thread-value layouts, Hexcute reuses the constraints to select optimal instructions and generate Hidet IR (Section 6). The generated IR is subsequently compiled into efficient GPU code using existing compiler passes.

### 3.2 Example: A Simple GEMM Kernel

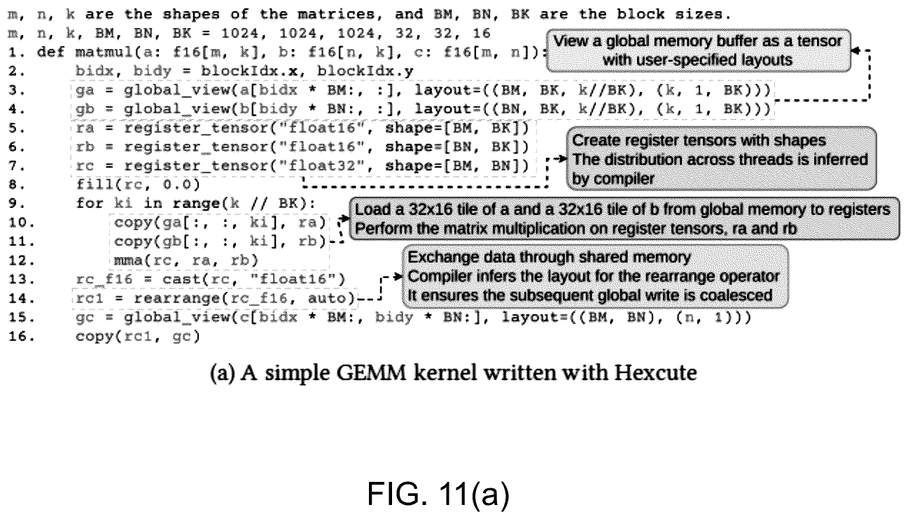

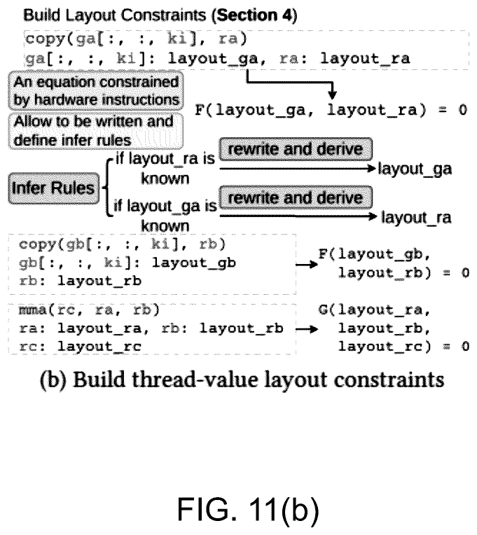

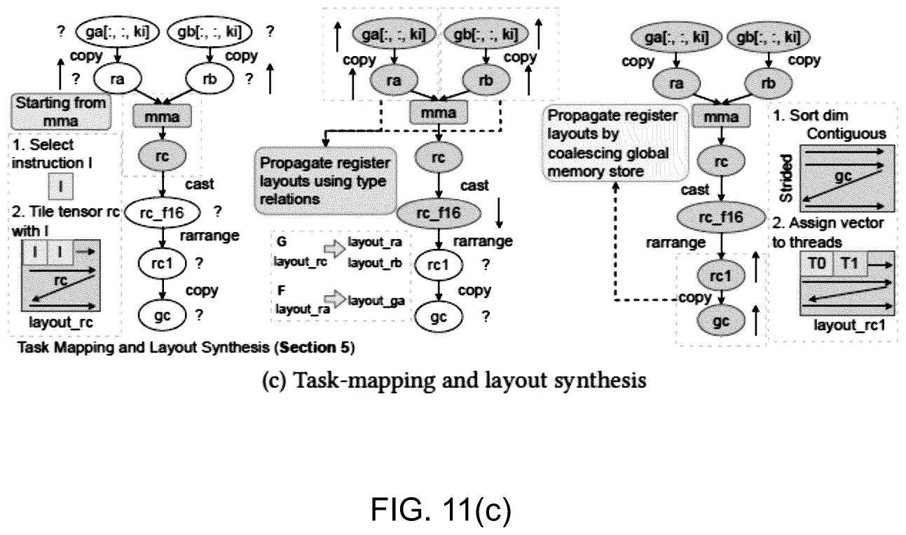

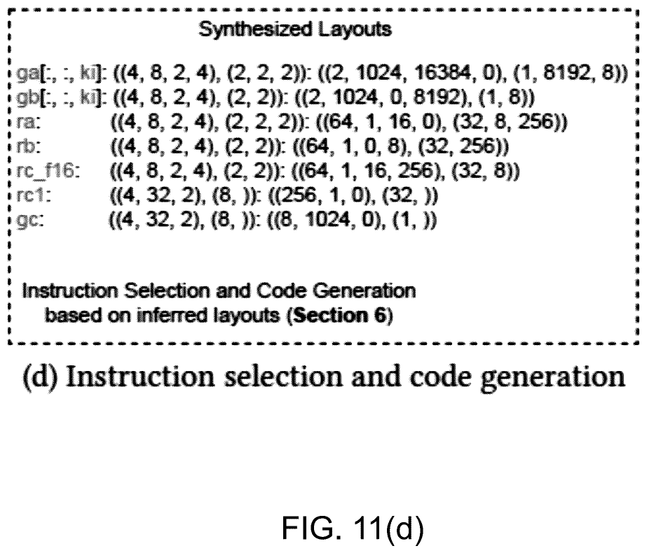

FIG. 11(a) illustrates a simple GEMM kernel that multiplies FP16 matrices a, b, and c using tile-level primitives in Hexcute. In this kernel, the matrix multiplication is tiled so that each thread block is responsible for computing a BM×BN tile of the matrix c. Lines 3-4 define global memory tensors with user-specified layouts. Specifically, Line 3 interprets a sub-tensor from matrix a as a three-dimensional tensor of shape (BM, BK, k/BK) with strides (k, 1, BK). Similarly, Line 4 reshapes a subtensor of b into shape (BN, BK, k/BK). The decomposition converts the tensor into an iterator, which allows efficient address calculation in the following loop. Lines 5-7 create register tensors ra, rb, and rc, with the compiler automatically inferring the data distribution for them. In Line 8, the accumulator rc is initialized to zero. The loop in Lines 9-12 iterates over k/BK tiles, loading tiles of a and b into registers (Lines 10-11) and performing matrix multiply-accumulate (mma) operations. After the loop, the FP32 accumulator rc is cast to FP16 in Line 14 and rearranged via shared memory in Line 15 to ensure coalesced global memory writes. Here, the rearrange operator is annotated with the auto keyword. This hints to the compiler to determine the optimal register tensor layout to ensure coalescing the subsequent store in Line 16. Finally, Lines 15-16 store the results into matrix c.

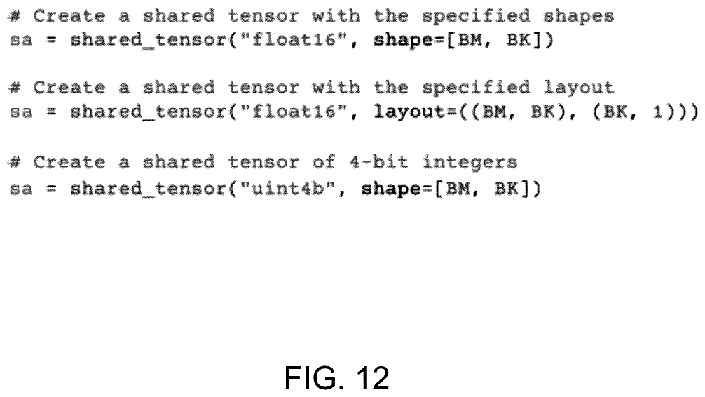

Hexcute supports two strategies for creating shared memory tensors, as shown in FIG. 9: either by explicitly declaring the shape or specifying the layout. One may choose CuTelayout [24] to represent the shared memory layout so that Hexcute can express the packed layout in FIG. 6. In both cases, the compiler automatically resolves shared memory bank conflicts through swizzling [26]. Low-precision tensors (e.g., 4-bit integers) are supported as first-class citizens (FIG. 12). Internally, register tensors use thread-value layouts to represent distributed data across threads. Table 1 below summarizes the tile-level operation semantics, and Appendix A (later) includes a formal definition of the operator syntax.

TABLE 1
Hexcute tile-level primitive semantics

| Primitives | Semantics |
|---|---|
| global_view(b, l) | View a global memory buffer b as a tensor |
| | with layout l |
| register_tensor(t, s) | Create a tensor with data type t and shape |
| | s in registers |
| shared_tensor(t, s) or | Create a tensor with data type t and shape |
| shared_tensor(t, l) | s or layout l in shared memory |
| copy(a, b) | Copy data from tensor a to tensor b |
| mma(c, a, b) | Perform matmul on tensors a, b, and c |
| cast(a, t) | Cast the tensor a to another data type t |
| rearrange(a, l) | Redistribute register tensor across the |
| | threads to layout l via shared memory |
| elementwise( . . . ) | Elementwise operations on tensors |
| reduce(a, d) | Reduce the tensor a along the dimension d |

### 3.3 Task Mapping and Layout Synthesis

Hexcute provides a programming model that allows fine-grained control comparable to Hidet[6], Graphene[11], and CUTLASS[30], while removing the need for error-prone specifications. Unlike the above works, Hexcute automatically infers task mappings for tile-level operations and layouts for shared/register tensors. A key insight is that the thread-value layout represents data distribution across threads and can become part of the tensor types. Hexcute then builds type constraints (relations) on the thread-value layouts, as detailed in Section 4.2. The thread-value layout constraint is conceptually an equation of thread-value layouts, which can be rewritten to define infer rules, as illustrated in FIG. 11(b). For example, the constraint of the copy in Line 9 in FIG. 11(a) is formalized as: F (layout_ga, layout_ra)=0, where layout_ga and layout_ra denote the thread-value layouts of ga[:, :, ki] and ra.

Hexcute employs a type-inference-based algorithm to synthesize distributed register/shared memory layouts and task mappings. In the GEMM example, the compiler starts from the mma operation. It selects a Tensor Core instruction I to tile the tensor rc, which determines the thread-value layout layout_rc, as illustrated on the left side of FIG. 11(c). Using the constraint G of the mma operation, it derives the thread-value layouts for ra and rb. Next, applying the constraint F from the copy operation, it determines the layouts for a[:, :, ki] and gb[:, :, ki], as illustrated in the middle of FIG. 11(c). Thus, the compiler incrementally propagates the thread-value layouts.

For the rearrange operator, which exchanges data through shared memory, no thread-value layout constraints apply to its output rc1. However, since rc1 is eventually stored in global memory, the optimal layout can be determined by coalescing the global memory write in Line 18, as illustrated on the right side of FIG. 11(c). After inferring all layouts, the algorithm synthesizes task mappings, generates low-level IR, and compiles the IR into GPU code via existing passes.

### 4. Thread-Value Layout Constraints

This section details the construction of thread-value layout constraints. Start by formalizing the behavior of memory and computing instructions.

### 4.1 Instruction Abstraction

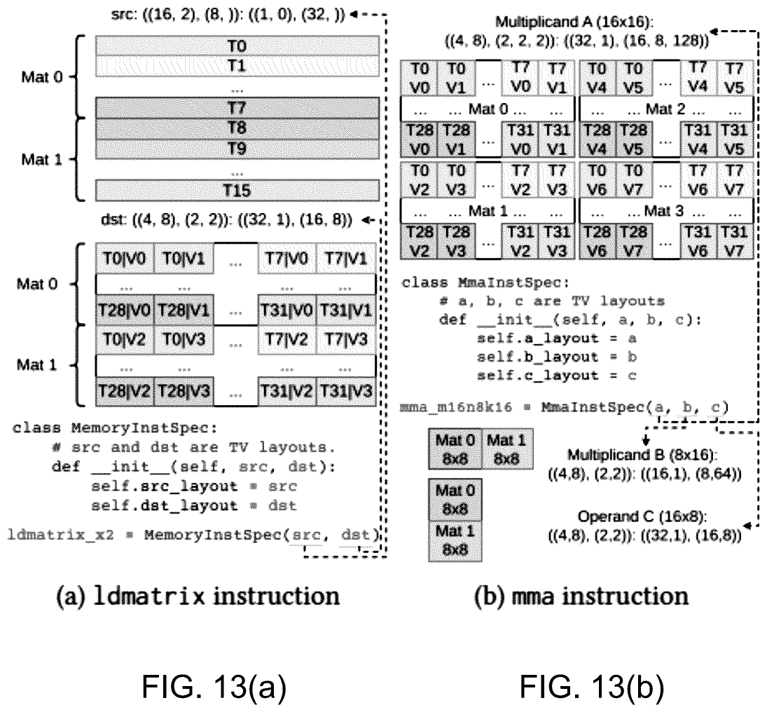

Modern GPU instructions such as Idmatrix and mma execute memory and compute tasks with coordinate thread groups. One may formalize their behavior using thread-value layouts. For example, in the Idmatrix instruction in FIG. 13(a), 32 threads collectively load two 8×8 matrices from shared memory. Each thread is responsible for loading one row in the 16×8 matrix, after which the data is redistributed across threads so that each thread holds 4 elements. This behavior can be modeled by two layouts: the layout, src, which maps thread-value pairs, (t, v), to logical shared memory addresses, and the layout, dst, which describes the distribution of output data across threads. Similarly, thread-value layouts specify the semantics of Tensor Core instructions. For example, The instruction mma.sync.aligned.m16n8k16.row. col executes small matrix multiplications with operands distributed across threads in a warp. As shown in FIG. 13(b), a thread-value layout defines the distribution of multiplicand A; the same approach applies to operands B and C. In summary, thread-value layouts fully capture the semantics of these instructions, allowing us to abstract their behavior as shown in the code examples in FIGS. 13(a) and 13(b).

### 4.2 Thread-Value Layout Constraints

To automate layout and task-mapping synthesis, first build constraints on the thread-value layout. Illustrate the derivation using a copy(a, b) operation.

Composite Mapping Functions. Let ƒ and g denote the thread-value layouts of tensors a and b, respectively. These layouts are functions that map a thread ID t and a value index v to a logical coordinate in the tensor tile:

$$f : ( t , v ) ↦ ( {m}_{T} , {n}_{T} ) , g : ( t , v ) ↦ ( {m}_{T} , {n}_{T} )$$

where m_{T} and n_{T} represent the row and column coordinates within the tensor tile.

Suppose a memory instruction I (used to implement the copy operation) is specified by its own input and output layouts, denoted by p and q, respectively. These layouts map the same thread-value pair to coordinates in the instruction tile. For instance, one might have:

$$p : ( t , v ) ↦ ( {m}_{I} , {m}_{I} ) , q : ( t , v ) ↦ ( {m}_{I} , {n}_{I} )$$

where m_{I} and n_{I} denote the row and column coordinates within the instruction tile.

By taking the inverse functions p⁻¹ and q⁻¹, one can convert instruction tile coordinates back to a thread-value pair. Composing these inverses with the tensor layouts gives the composite mappings: ƒ∘p⁻¹ and g∘q⁻¹, which map coordinates from the instruction tile to the corresponding positions in the input and output tensor tiles, respectively. Since the copy operation transfers an identical logical region from the input tensor to the output tensor, these composite mappings must be equal: ƒ∘p⁻¹=g∘q⁻¹.

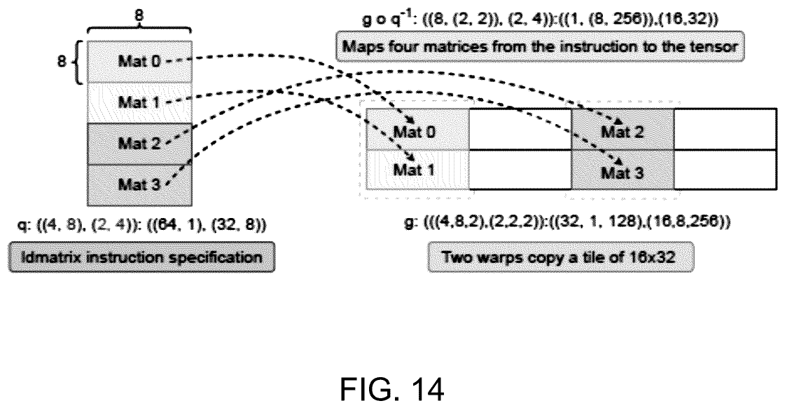

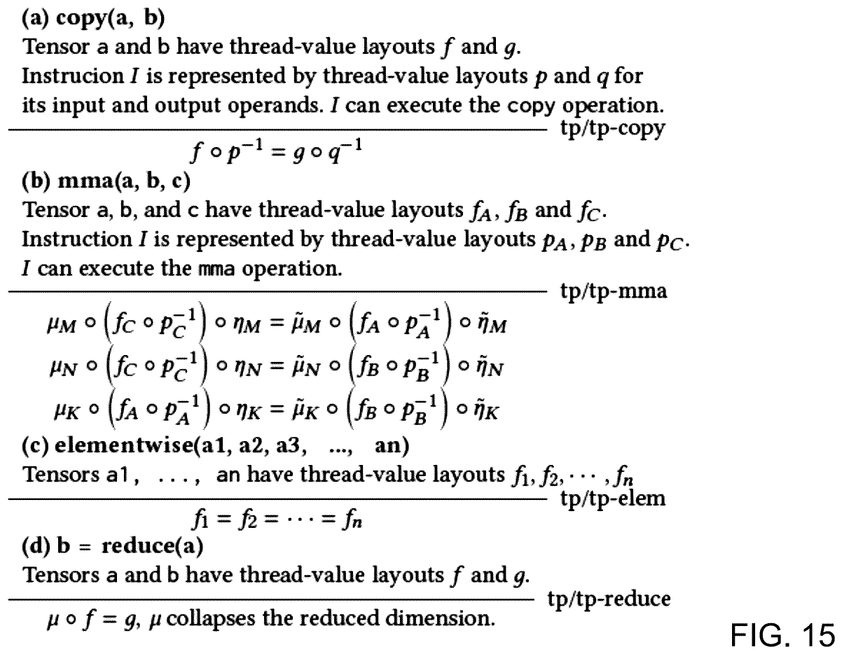

An Intuitive Example of g∘q⁻¹. Consider the example of an Idmatrix instruction with an output layout defined as q: ((4,8),(2,4)):((64,1),(32,8)). Suppose the output tensor b has a layout defined as g: ((4,8,2),(2,2,2)):((32,1,128),(16,8,256)), representing two warps holding a 16×32 tile. In this scenario, the mapping function g∘q⁻¹ maps four 8×8 matrices produced by Idmatrix to four distinct locations in the output tensor, as shown in FIG. 14.

Generalized Constraints. FIG. 15 summarizes the constraints for key operations. FIG. 15, part (a) formalizes the constraint for the copy operation. For the mma operation, similarly construct the composite functions to bridge the instruction and the data tensors, as shown in FIG. 15, part (b). Since the tensors a, b, and c have different coordinate spaces (i.e., [symbol] [0,M)× [symbol] [0,K) for a, [symbol] [0,N)× [symbol] [0,K) for b, and [symbol] [0,M)× [symbol] [0,N) for c, where M, N, and K denote the matrix dimensions), define helper functions μ* and η* to connect the composite mappings. For example, ηM maps the instruction row coordinate mI into the two-dimensional space: ηM:mI [symbol] (mI, 0), and the projection function μM extracts the M dimension from the data tensor coordinate pair (mT, nT): μM: (mT, nT) [symbol] mT. A detailed discussion about the constraints for mma is provided in the Appendix. For the elementwise operation, all tensors must have the same thread-value layouts, as shown in FIG. 15, part (c). Lastly, the constraint for the reduce operation is provided in FIG. 15, part (d), where a projection function η: [symbol] → [symbol] collapses the reduced dimension (for example, μ: (m,n) [symbol] m for a reduction along n dimension).

### 5. Task Mapping and Layout Synthesis

### 5.1 Thread-value Layout Synthesis

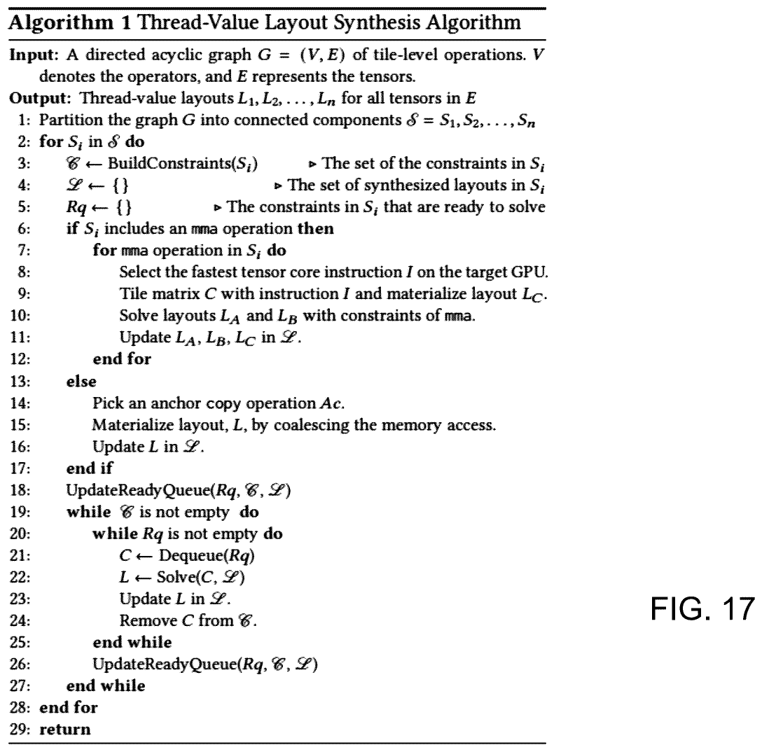

Building on the thread-value layout constraints in FIG. 15, one may design Algorithm 1 in FIG. 17, to synthesize thread-value layouts.

Graph Partition. The algorithm first constructs a directed acyclic graph (DAG) of tile-level operations and partitions it into connected subgraphs separated by shared memory reads and writes (Line 1). For each subgraph, the algorithm selects anchor operators and initializes the thread-value layouts for the inputs and outputs. It then builds thread value layout constraints and propagates the layouts based on the constraints detailed in FIG. 15. In subgraphs containing mma operations, these operations are chosen as anchors due to their critical impact on kernel performance. If mma operations are absent, the algorithm selects the copy operation that transfers the most data as the anchor. One may choose this design because non-mma operations are typically memory-bound, which makes the copy operation important to kernel performance. In addition, this is feasible because every connected component includes at least one copy operation that reads or writes data; otherwise, the subgraph would be removed during dead code elimination.

Initialization. For an mma anchor, the algorithm selects the fastest Tensor Core instruction available on the target GPU and tiles the matrix C with the instruction, which materializes the layout for C (Lines 8-9). It then solves the layouts for A and B using the constraints in FIG. 15, part (b) (Lines 10-11). For a copy anchor, the layout is constructed by coalescing memory accesses (Line 15). The process begins by sorting the memory layout dimensions by their strides. The vector size for the Id/st instruction is then determined by analyzing the divisibility of the strides. Finally, the thread-value layout is constructed such that consecutive threads access contiguous vectors in memory, thereby coalescing the memory access.

Layout Solving. The algorithm maintains a set of remaining constraints, C, and a ready list of constraints, Rq for each subgraph (Lines 3-5). A constraint is added to Rq when only one thread-value layout variable remains unknown. At that point, one may rewrite the constraint so that the unknown variable appears on the left-hand side of the equation (Line 22). For example, if the constraint for a copy operation is ready and the layout g is known, select an available instruction I with input and output layouts p and q, and rewrite the equation from FIG. 12 as ƒ=g∘q⁻¹∘p. Using this equation, one may derive the unknown layout ƒ by applying the algebraic operations of layouts. As new layouts become known, update the ready list accordingly. This process repeats until all constraints in C have been resolved.

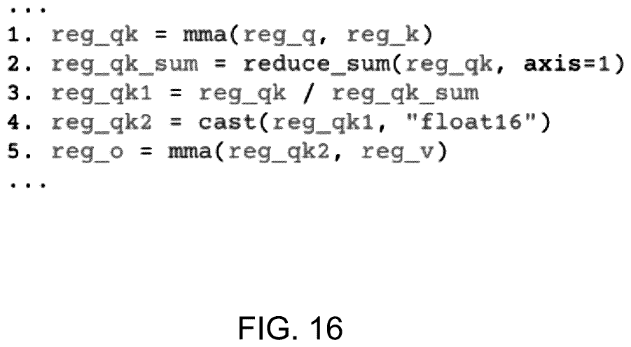

Conflict Handling. For kernels with multiple GEMM operations (e.g., FlashAttention [3]), the algorithm can propagate thread-value layouts starting from central mma operations. Without loss of generality, consider an example with two matrix multiplications and a reduction in between, as shown in FIG. 16. First, the compiler materializes the thread-value layouts for the mma operations at Line 1 and Line 3. Then, the constraints for the reduce_sum and cast operations at Line 2 and Line 4 become ready to solve. Once these constraints are resolved, and the thread-value layouts of reg_qk1, reg_qk, and reg_qk_sum are fully determined, the compiler verifies their logical consistency, ensuring the register tensors are distributed across the threads in the same way. If the consistency condition is not met, the compiler injects a rearrange operator on reg_qk1 to produce a valid program. However, this approach incurs data exchange through shared memory, which may introduce additional overhead. To circumvent this overhead, Hexcute allows users to annotate the task mapping for the mma operations and ensure consistency.

Expanding Search Tree. In cases where multiple valid instructions exist for a single copy operation, Algorithm 1 in FIG. 17 is extended with depth-first search (DFS) and backtracking. This extension transforms the search space into a tree, with each leaf node representing a valid program. One may then build an analytical latency model to estimate the latency of each leaf program, select the one with the lowest predicted latency, and generate the lower-level IR.

### 5.2 Shared Memory Layout Synthesis

For shared memory synthesis, represent the shared memory layout M as the composition, M=S∘m, where m: [symbol] → [symbol] is a memory layout function subject to instruction

alignment requirements and S: [symbol] → [symbol] is a swizzle function that permutes shared memory addresses to eliminate bank conflicts. The goal is to find the satisfied functions,m and S.

Alignment Requirement. First consider synthesizing the memory layout functionm. As a concrete example, suppose a copy operation loads a float16 tile of size 4×64 from shared memory to registers. Assume a 16-byte aligned Id instruction is selected, and the thread-value layout ƒ inferred by Algorithm 1 is: ƒ=((8,), (8, 4)): ((32,), (4, 1)). Composing layout ƒ with memory layoutm yields the addresses assigned to each thread. Since alignment requirements dictate addresses are multiples of 16 bytes (8 float16 elements), construct the constraint: m∘ƒ=((8,), (8, 4)): ((d₁,), (1, d₂)), where d₁ and d₂ are undetermined strides. By multiplying by the inverse ƒ⁻¹, obtain a candidate layout: m=(4, 8, 8): (d₂, 1, d₁). Based on the observation, the compiler traverses the program and applies this approach to each copy operation involving the same shared memory tensor. By comparing candidate layouts from all operations, the compiler synthesizes a unified memory layoutm satisfying all alignment constraints. A detailed discussion about the example and the general case is provided in the Appendix part C.

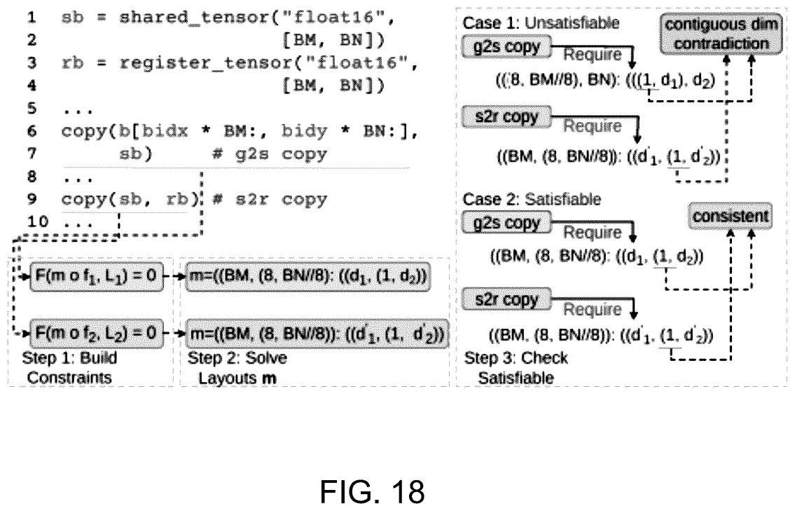

For example, FIG. 18 illustrates a code snippet with shared memory read/write operations, where BM and BN represent known block sizes. The algorithm constructs alignment constraints for g2s and s2r copy operations (Lines 6 and 9). Solving these constraints partially determines the memory layout strides, as depicted in the middle of FIG. 18. In the example, a dimension with shape 8 and stride 1 indicates the 8 elements are contiguous in memory, ensuring 16-byte alignment. Finally, the compiler checks layout consistency by verifying stride satisfiability across operations. The top-right case in FIG. 18 is unsatisfiable due to conflicting contiguous dimensions. Conversely, the bottom-right scenario remains satisfiable. If all constraints are met, the compiler finalizes unknown strides d₁ and d₂ to complete the synthesis of the shared memory layout.

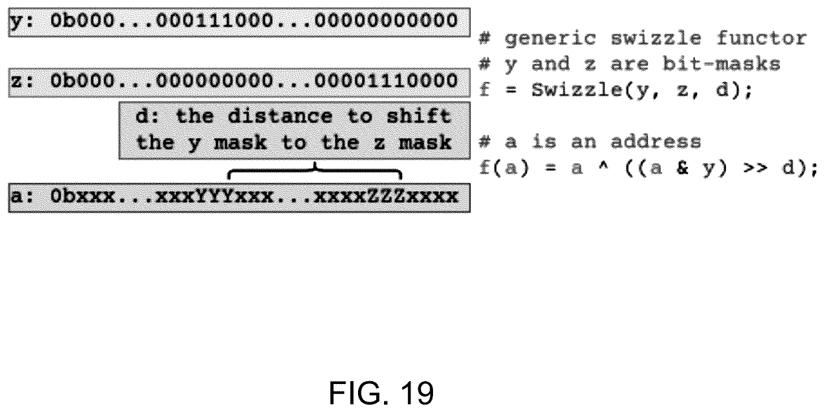

Eliminate Bank-Conflicts. To eliminate the bank conflict in the shared memory access, leverage the generic swizzle function defined in CuTe [24], which is shown in FIG. 19. One may design a compiler pass that traverses the program and identifies all copy operations that access the same shared memory buffer. The pass then enumerates the applicable swizzle functions and selects the one most effectively reducing bank conflicts. This is done by analyzing the memory addresses accessed by the threads within a warp and choosing the swizzle function that minimizes overlapping accesses to the same bank.

### 6 Code Generation

After synthesizing thread-value layouts, shared memory layouts, and task mappings, generate the Hidet IR for the tile-level primitives. The code generation process includes two steps: instruction selection and loop generation. Instruction selection leverages the thread-value layout constraints established in FIG. 15 to find the best instruction. For each tile-level operation, generate a loop that repeatedly executes the instruction. The loop structure is determined by analyzing the thread-value layout of the tensor operands.

### 7 Evaluation

One may implement Hexcute in Python with about 10K lines of code. Built on top of Hidet, one may introduce new tile-level primitives and implement compiler passes to lower these primitives to low-level Hidet IR. A system is proposed to ensure the correctness and performance of GPU programs. One may leverage the layout algebra of CuTe to build type constraints, but unlike CuTe, Hexcute's code generation directly emits pure C code without depending on any C++ templates in CuTe [30]. While Hexcute increases the compilation time compared to Hidet, as the DFS enumerates all kernel variations with different instructions, employ the hardware-centric searching space [6] to keep compilation time acceptable. In the following sections, the effectiveness of Hexcute is demonstrated via extensive benchmarks.

### 7.1 Experimental Setup

The experiments are conducted on three NVIDIA GPUs, RTX4090, A100, and H100, representing the Ampere, Ada, and Hopper architectures. To avoid experiment fluctuations, lock the GPUs' frequencies and clear the L2 cache before running all the microbenchmarks. Unless otherwise specified, use float32 as the accumulator for mma instruction.

### 7.2 Operator Benchmark

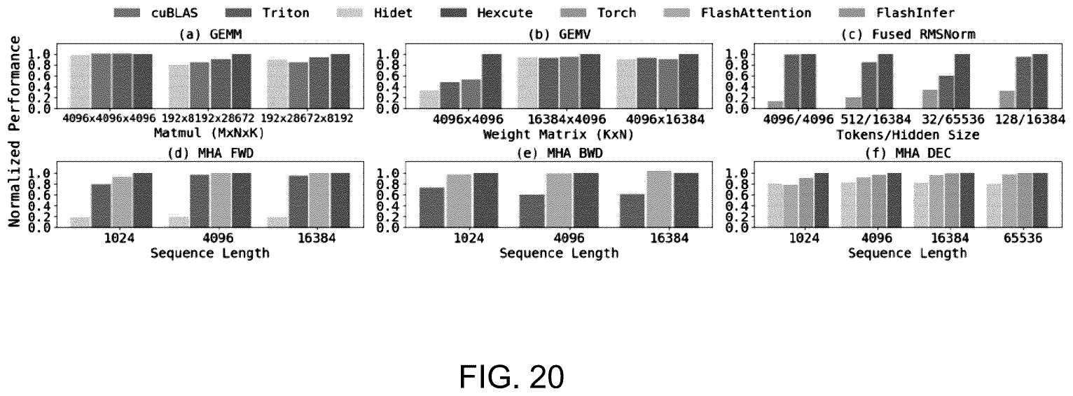

To demonstrate Hexcute's generality across a wide range of DL operators, evaluate its performance on six operator benchmarks. FIG. 20 compares Hexcute against compilers such as Hidet [6](v0.6.0.dev) and Triton [31](v3.0.0), as well as established hand-written kernel libraries. The present kernel library baseline includes cuBLAS [23](v12.4), FlashAttention [3](v2.6.3), and FlashInfer [39](v0.0.3). The results may be summarized as follows:

GEMM is the key machine-learning operator on GPUs. This experiment evaluates if Hexcute can achieve performance comparable to cuBLAS, the most optimized GPU GEMM library. The first matmul is compute-bound, and Hexcute perfectly matches cuBLAS performance. In the other two matmuls, where a tall and a flat matrix B are selected, tuning tile sizes allows Hexcute to produce kernels that exceed the performance of Triton, Hidet, and cuBLAS.

GEMV, short for general matrix-vector multiplication, is widely used in LLM serving systems [13]. Due to its long-tail property, this operator is often not well-optimized. Hexcute implements the GEMV layer using the reduce operator and, in the memory-latency-bound case, Hexcute outperforms other kernel providers by 46.4%.

RMSNorm is a layer normalization widely used in language models. Hexcute exploits parallelism in the hidden dimension and applies inter-thread-block reduction, which cannot be done by Triton, and achieves up to 1.67× speedup over it.

MHA FWD, the multi-head attention forward layer, is evaluated under compute-bound conditions. Hidet uses manually designed layouts and task mappings that are not fully optimized. In contrast, Hexcute automatically generates efficient ones, matching the performance of FlashAttention, the state-of-the-art attention library.

MHA BWD, the multi-head attention backward layer, is important for training language models. In the present experiment, Hexcute matches the performance of FlashAttention, which is the best backward kernel available. To optimize this operator, developers balance caching the Q, K, and V tensors in shared memory or registers. However, Triton cannot do this because it does not expose these hardware hierarchies. By carefully orchestrating pipelining, Hexcute outperforms Triton's solution by up to 40.3%.

MHA DEC is the attention layer used during decoding, a key part of LLM serving, and is often memory-bound. Hexcute matches the performance of top hand-written libraries like FlashAttention and FlashInfer. By splitting the KV cache loading and using compiler-generated optimal task mappings and layouts, Hexcute achieves 20% lower latency than Hidet.

### 7.3 Case Studies

To demonstrate that Hexcute generates efficient code for low-precision computations, one may compare Hexcute against compiler baselines, including Ladder (v0.0.1.dev15) and Triton (v3.0.0), as well as against Marlin [8](commit 2f6d7c), the best mixed-type GEMM library.

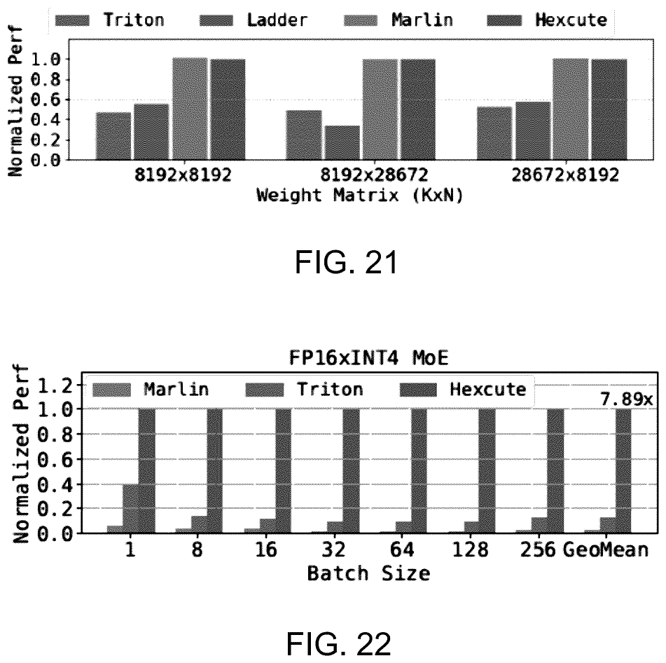

Mixed-type GEMM. FIG. 21 compares Hexcute to Triton, Ladder, and Marlin on a FP16×INT4 matmul kernel on RTX4090. The results show that Hexcute brings up to 2.9× and 2.1× speedups over Triton and Ladder, respectively, while matching the performance of Marlin. One may analyze these improvements in detail. Triton and Ladder's layout systems cannot express the packed layout in FIG. 6, so they select suboptimal layouts that introduce extra overheads, as shown in FIG. 5 parts (a) and (b). In contrast, Hexcute exposes shared memory and register abstractions to explicitly express the optimal data pipeline shown in FIG. 5, part (c). Moreover, the layout synthesis algorithm finds the layout that satisfies the constraints without incurring additional shuffles through shared memory or registers. For example, Hexcute discovers a shared layout ((8,2,8),(2,64)):((4,2,2048),(1,32)), which allows loading a INT4 tile of 128×128 with Idmatrix.

Mixed-type MoE Layer. FIG. 22 compares the performance of a mixed-type MoE layer on the H100. Marlin [8] designs the efficient layout and data pipeline to hide the cost of dequantization, but it is written by hand and hard to adapt to complex scenarios like MoE. So, Marlin implements the MoE layer by launching a separate kernel for each expert, introducing significant kernel launch overhead. Triton fuses all experts into a single kernel to remove the launch overhead, but its layout selection and data pipeline are suboptimal. In contrast, Hexcute combines the benefits of both approaches, achieving an average speedup of 7.89× over Triton.

### 7.4 End-to-end Benchmark

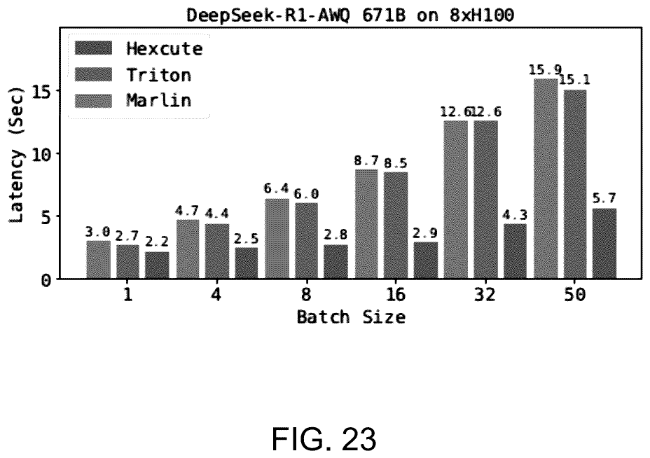

To evaluate whether Hexcute-generated kernels are useful in practice, the mixed-type MoE kernels were integrated into vLLM [17](v0.7.3) and evaluated the end-to-end performance of the DeepSeek-R1-AWQ model on 8×H100 GPUs. As shown in FIG. 23, Hexcute reduces latency by 16%-65% compared to the best existing compilers and hand-written kernels. In this experiment, latency is measured as the time required to generate 100 output tokens from 100 input tokens.

### 7.5 Ablation Study

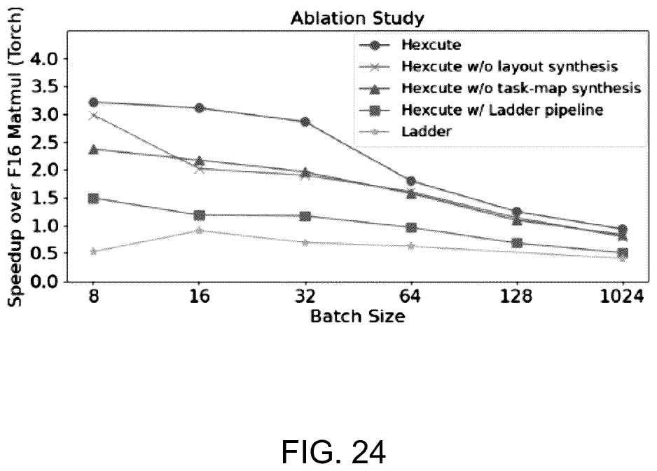

An ablation study was conducted on an A100 GPU using a linear layer from Llama 3.1 (70B) with float16 activations and int4 weights (n=28672, k=8192). The experiment compares Hexcute's optimized kernel with kernels generated by disabling individual compiler passes, as shown in FIG. 24. On average, performance drops by 19.3%, 52.5%, and 21.2% when shared memory layout synthesis, task-mapping synthesis, and Hexcute's optimized software pipeline (replaced by Ladder's) are disabled, respectively. Notably, even when replacing Hexcute's optimal pipelining with Ladder's, Hexcute still outperforms Ladder, demonstrating the effectiveness of its task mapping and layout synthesis. These results highlight the importance of Hexcute's compiler optimizations.

### 8 Related Work

Most existing DL compilers [2, 7, 27, 40, 42-44] focus on operators with mainstream data types like FP16 and FP32, providing limited support for low-precision computations. Ladder [35] extends TVM [2] to optimize mixed-type operators. However, Ladder [35] leverages TVM's loop-oriented schedule primitives, which makes it hard to express some key optimizations like software pipelining and fine-grained dataflow. In contrast, Hexcute proposes a tile-based programming language that explicitly exposes shared memory and register abstractions, which allows us to implement these optimizations for mixed-type operators. Hidet [6] employs the task mapping programming model to schedule the tensor programs. Hexcute adopts a similar approach but simplifies the programming efforts by automating the synthesis of task mappings and layouts with a type-inference-based algorithm. Triton [31] is another tile-based programming language, but it lacks the exposure of shared memory and registers, limiting its applicability to low-precision optimizations. Graphene [11] leverages the Layout concept to represent the GPU optimizations such as tiling and bank-conflict elimination, but it does not support low-precision computations and requires manual specifications for the optimal layouts. Specialized libraries such as CUTLASS [30] and Marlin [8] demonstrate efficient low-precision kernels (e.g., FP16×INT4 matrix multiplication) through hand-tuned templates or manual implementations. However, these solutions demand considerable engineering efforts and are hard to generalize to broader low-precision computations.

### 9 Conclusions

The discussion above presents Hexcute, a tile-based programming language that exposes hardware hierarchies, enabling fine-grained optimizations for mixed-type operations. To reduce programming effort, Hexcute automates layout synthesis with a type-inference-based algorithm. Experiments show that Hexcute generalizes across a wide range of DL operators and achieves competitive performance. Moreover, Hexcute generates efficient code for low-precision computations, achieves 1.7-11.28× speedup over existing compilers for operators, and brings up to 2.91× speedup in the end-to-end evaluation.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as transitory or non-transitory storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the computing environment 10, compiler 12, or computing device 40, any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

### APPENDIX

### Part A—Tile-Level Operation Specifications

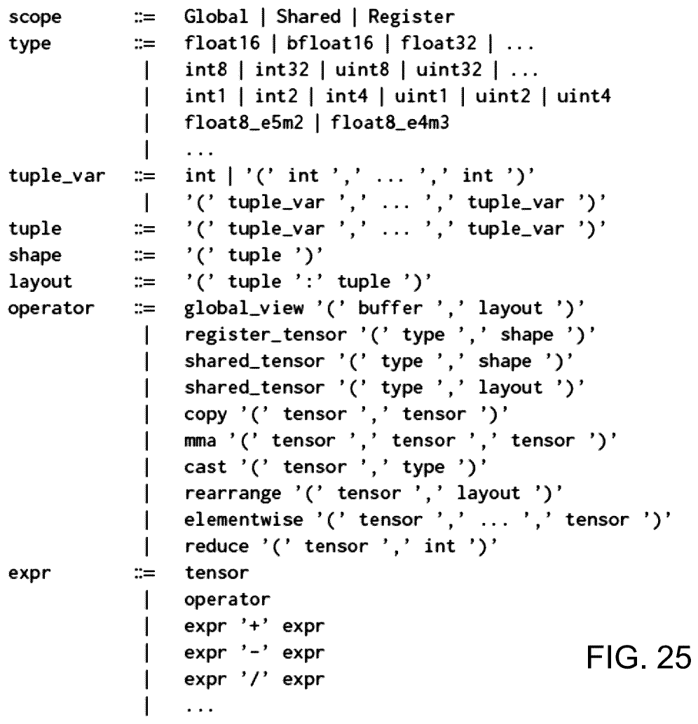

This section details the syntax of tile-level operations in Hexcute, which is illustrated in FIG. 25. Hexcute defines memory scopes, such as Global, Shared, and Register, to explicitly represent a tensor's memory space. In addition, Hexcute supports low-precision data types such as int1 |2|4, uint1|2|4, and specialized floating-point formats like float8_e5m2.

Building on CuTe's methodology, Hexcute employs recursively defined integer tuples to specify hierarchical shapes and layouts, which enables the construction of complex memory layouts and thread-value layouts. Layouts are expressed as colon-separated pairs of integer tuples ((tuple:tuple)). Moreover, Hexcute supports primitive tensor operations in tensor programming, including data movement (copy), matrix multiplication (mma), type conversion (cast), layout transformation via shared memory (rearrange), elementwise operations, and reductions, which can be combined with arithmetic expressions to specify computations flexibly.

### Part B—Thread-Value Layout Constraints for Mma Operation

In this section, a detailed discussion of the threadvalue layout constraints for the mma operation is presented.

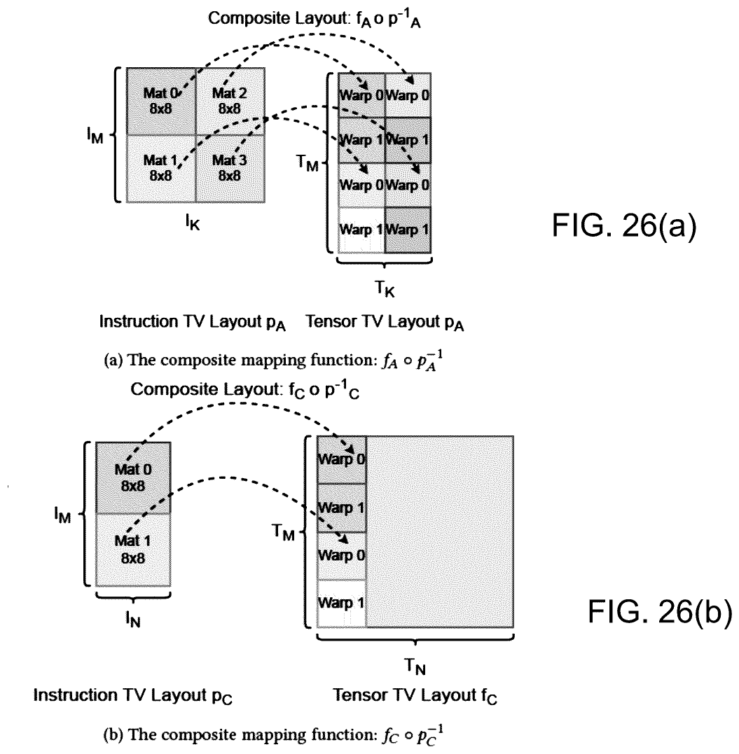

As shown in FIG. 26, consider an mma operation where the operand tensors A, B, and C have thread-value layouts ƒ_{A}, ƒ_{B}, and ƒ_{C}, respectively. The Tensor Core instruction mma.sync.aligned.m16n8k16.row.col is used to execute the operation, with its operands A, B, and C having thread-value layouts p_{A}, p_{B}, and p_{C}, respectively. FIG. 26(a) shows that the composite mapping function ƒ_{A} ∘p_{A}⁻¹ maps the four matrices from the instruction tile A to distinct positions in tensor A, while FIG. 26(b) illustrates that ƒ_{C}∘p_{c}⁻¹ maps the two matrices in the instruction tile C to different positions in tensor C.

An Intuitive Example. Consider an mma operation where the operand tensors A, B, and C have thread-value layouts ƒ_{A}, ƒ_{B}, and ƒ_{C}, respectively. Suppose that the Tensor Core instruction mma.sync.aligned.m16n8k16.row.col, represented by thread-value layouts p_{A}, p_{B}, and p_{C} for operands A, B, and C, is selected to execute the mma operation. Similar to the copy operation, one can relate the thread-value layouts of the instruction to those of the tensors. For example, FIG. 26(a) illustrates the composite mapping function ƒ_{A}∘p_{A}⁻¹ maps the four matrices from the instruction tile A to distinct positions in tensor A. Similarly, FIG. 26(b) shows the composite mapping function ƒ_{C}∘p_{C}⁻¹ maps the two matrices in the instruction tile C to different positions in tensor C. Since the instruction operands A and C have the same dimension I_{M} and tensors A and C share the same dimension T_{M}, the restrictions of the mapping functions ƒ_{A}∘p_{A}⁻¹ and ƒC∘p−1 C to the M dimension yields the same mapping from I_{M} to T_{M}. Based on this observation, formalize the constraints of the mma operation as stated in Theorem 1.

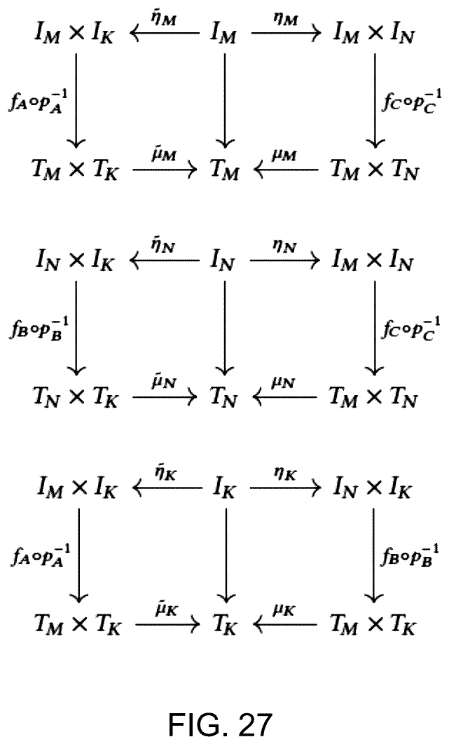

As shown in FIG. 27, the thread-value constraints for matrices A, B, and C in the mma operation represented using commutative diagrams. The projection functions, μ_{M}, μ^{\tilde{ }}_{M}, μ_{N}, μ^{\tilde{ }}_{N}, μ_{K}, and μ^{\tilde{ }}_{K}, and the natural embedding functions, η_{M}, η^{\tilde{ }}_{M}, η_{N},η^{\tilde{ }}_{N}, η_{K}, and η^{\tilde{ }}_{K}, are defined in Theorem 1. The Cartesian product T_{M}×T_{N}, T_{M}×T_{K}, and T_{N}×T_{K}, represent the coordinate spaces of matrices, A, B, and C in the Mma operation, while the Cartesian product I_{M}×I_{N}, I_{M}×I_{K}, and I_{N}×I_{K}, represent the coordinate spaces of A, B, and C operands in instruction I.

Theorem 1. Consider a mma operation where the tensors A, B, and C have the thread-value layouts ƒ_{A}, ƒ_{B}, and ƒ_{C}, respectively. Suppose one uses a Tensor Core instruction I, represented by the thread-value layouts p_{A}, p_{B}, and p_{C} for the A, B, and C operands, to execute this operation. Let the projection be defined as follows:

$${μ}_{M} : ( {m}_{T} , {k}_{T} ) ↦ {m}_{T} , {\tilde{μ}}_{M} : ( {m}_{T} , {n}_{T} ) ↦ {m}_{T}$$

$${μ}_{N} : ( {n}_{T} , {k}_{T} ) ↦ {n}_{T} , {\tilde{μ}}_{N} : ( {m}_{T} , {n}_{T} ) ↦ {n}_{T}$$

$${μ}_{K} : ( {m}_{T} , {k}_{T} ) ↦ {k}_{T} , {\tilde{μ}}_{K} : ( {n}_{T} , {k}_{T} ) ↦ {k}_{T}$$

and the natural embedding functions are defined:

$${η}_{M} : {m}_{I} ↦ ( {m}_{I} , 0 ) ∈ {I}_{M} \times {I}_{N} , {\tilde{η}}_{M} : {m}_{I} ↦ ( {m}_{I} , 0 ) ∈ {I}_{M} \times {I}_{K}$$

$${η}_{N} : {n}_{I} ↦ ( 0 , {n}_{I} ) ∈ {I}_{M} \times {I}_{N} , {\tilde{η}}_{N} : {n}_{I} ↦ ( {n}_{I} , 0 ) ∈ {I}_{N} \times {I}_{K}$$

$${η}_{K} : {k}_{I} ↦ ( 0 , {k}_{I} ) ∈ {I}_{M} \times {I}_{K} , {\tilde{η}}_{K} : {k}_{I} ↦ ( 0 , {k}_{I} ) ∈ {I}_{N} \times {I}_{K}$$

where m_{T}, n_{T}, and k_{T} are the coordinates within tensors of the mma operation, and m_{I}, n_{I}, and k_{I} are the coordinates within the operands of the instruction I. The Cartesian product I_{M}×I_{N}, I_{M}×I_{K}, and I_{N}×I_{K}, represent the coordinate spaces of A, B, and C operands of instruction I. Then, the following consistency equations hold:

$${μ}_{M} ∘ ( {f}_{C} ∘ {p}_{C}^{- 1} ) ∘ {η}_{M} = {\tilde{μ}}_{M} ∘ ( {f}_{A} ∘ {p}_{A}^{- 1} ) ∘ {\tilde{η}}_{M}$$

$${μ}_{N} ∘ ( {f}_{C} ∘ {p}_{C}^{- 1} ) ∘ {η}_{N} = {\tilde{μ}}_{N} ∘ ( {f}_{B} ∘ {p}_{B}^{- 1} ) ∘ {\tilde{η}}_{N}$$

$${μ}_{K} ∘ ( {f}_{A} ∘ {p}_{A}^{- 1} ) ∘ {η}_{K} = {\tilde{μ}}_{K} ∘ ( {f}_{B} ∘ {p}_{B}^{- 1} ) ∘ {\tilde{η}}_{K}$$

Proof. In the mma operation, the thread-value layouts ƒ_{A}, ƒ_{B}, and ƒ_{C} of the matrix A, B, and C map thread ID and value ID to the logical positions within the tensors:

$${f}_{A} : ( t , v ) ↦ ( {m}_{T} , {k}_{T} )$$

$${f}_{B} : ( t , v ) ↦ ( {n}_{T} , {k}_{T} )$$

$${f}_{C} : ( t , v ) ↦ ( {m}_{T} , {n}_{T} )$$

Similarly, for the Tensor Core instruction I, represented by the thread-value layouts p_{A}, p_{B}, and p_{C} for the A, B, and C operands, these layouts map thread ID and value ID to the operand coordinates:

$${p}_{A} : ( t , v ) ↦ ( {m}_{I} , {k}_{I} )$$

$${p}_{B} : ( t , v ) ↦ ( {n}_{I} , {k}_{I} )$$

$${p}_{C} : ( t , v ) ↦ ( {m}_{I} , {n}_{I} )$$

To relate the tensor layouts with the instruction layouts, one may construct composite functions from the instruction operands to the matrix tensors:

$${f}_{A} ∘ {p}_{A}^{- 1} : ( {m}_{I} , {k}_{I} ) ↦ ( {m}_{T} , {k}_{T} )$$

$${f}_{B} ∘ {p}_{B}^{- 1} : ( {n}_{I} , {k}_{I} ) ↦ ( {n}_{T} , {k}_{T} )$$

$${f}_{C} ∘ {p}_{C}^{- 1} : ( {m}_{I} , {n}_{I} ) ↦ ( {m}_{T} , {n}_{T} )$$

Now, let's consider the first equation in Theorem 1. To relate the mapping functions ƒ_{A}∘p_{A}⁻¹ (for matrix A) and ƒ_{C}∘p_{C}⁻¹ (for matrix C), one may construct the following mappings by composing the projection and embedding functions:

$${μ}_{M} ∘ ( {f}_{C} ∘ {p}_{C}^{- 1} ) ∘ {η}_{M} : {m}_{I} ↦ {m}_{T}$$

$${\tilde{μ}}_{M} ∘ ( {f}_{A} ∘ {p}_{A}^{- 1} ) ∘ {\tilde{η}}_{M} : {m}_{I} ↦ {m}_{T}$$

Since both functions map from the instruction operands'(A and C) m-coordinate to the matrix tensors' (A and C) m-coordinate, these functions are identical. This relationship is represented by a commutative diagram (top of FIG. 27). Similarly, one can relate the mappings for matrix B and matrix C(the second equation in Theorem 1) and for matrix A and matrix B (the third equation in Theorem 1). These relationships are represented with communicative diagrams, as shown in the middle and bottom of FIG. 27.

### Part C—Shared Memory Layout Synthesis

In this section, a detailed discussion of the memory layout constraint derivation is discussed. One may begin with the example in Section 5.2 to illustrate the core concepts.

The Concrete Example. In the example in Section 5.2, one may have a copy operation that loads a float16 tile of size 4×64 from shared memory into the register files. In addition, assume a 16-byte Id instruction is selected to implement the copy operation, and the thread-value layout ƒ of the register tensor inferred by Algorithm 1 is:

$$f = ( ( 8 , ) , ( 8 , 4 ) ) : ( ( 32 , ) , ( 4 , 1 ) ) .$$

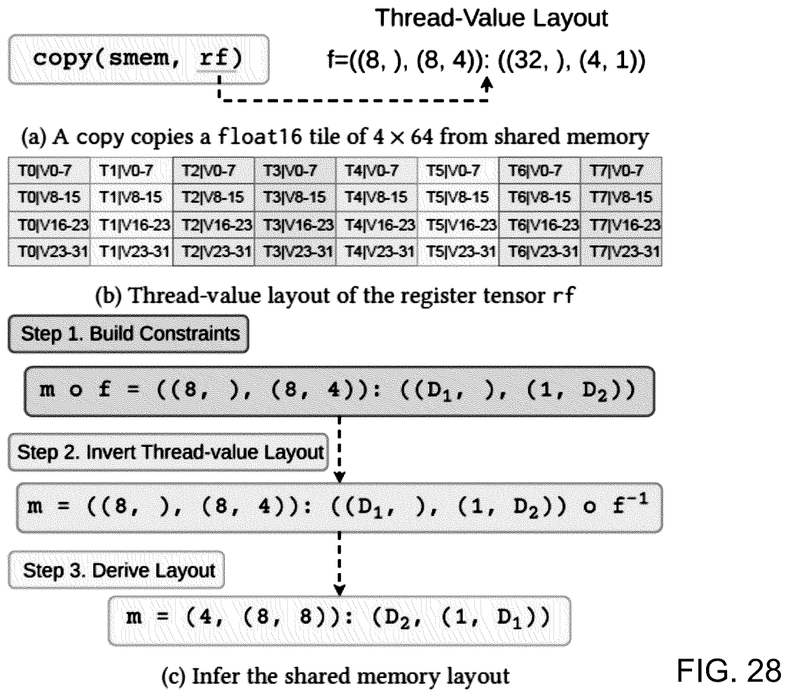

FIG. 28 visualizes the data distribution of the register tensor: 8 threads each access 8×4 elements.

The Id instruction requires 16-byte alignment. Since each float16 element occupies 2 bytes, the 16-byte alignment mandates that the innermost 8 elements (16 bytes/2 bytes per element) accessed by each thread must be contiguous in shared memory. In addition, the composition of the shared memory layoutm and the thread-value layout ƒ yields the address assigned to each thread. Thus, the composite function m∘ƒ satisfies:

$$m ∘ f = ( ( 8 , ) , ( 8 , 4 ) ) : ( ( {d}_{1} , ) , ( 1 , {d}_{2} ) )$$

where d₁ and d₂ are some undetermined strides.

To solve for m, one may composite the right inverse ƒ−1 with both sides of the above constraints:

$$\begin{matrix}m = ( ( 8 , ) , ( 8 , 4 ) ) : ( ( {d}_{1} , ) , ( 1 , {d}_{2} ) ) ∘ {f}^{- 1} \\ = ( 4 , 8 , 8 ) : ( {d}_{2} , 1 , {d}_{1} )\end{matrix}$$

This equation implies that the layout m should have a shape of (4, 8, 8), with the middle dimension (size 8) being contiguous (stride 1), while the remaining strides (d₁, d₂) are undetermined free strides. Based on this observation, one can apply the same approach to every copy operation corresponding to a shared memory tensor. By comparing the candidate memory layouts, one can verify that the alignment requirements are satisfiable and then materialize a shared memory layout that meets all constraints.

General Case. Consider a copy operation where the input and output tensors have thread-value layouts ƒ and g, respectively, and each data element in the tile occupies K bytes. Without loss of generality, assume the input tensor resides in shared memory and that the instruction I executing the copy requires an alignment of L bytes. Composing the thread-value layout ƒ with the memory layout m assigns a memory address to each thread within the tile. Since every address is a multiple of L bytes, the following is required:

$$m ∘ f = ( ( {t}_{0} , … , {t}_{m} ) , ( L / K , {v}_{1} , … , {v}_{n} ) ) : ( ( {d}_{0} , … , {d}_{m} ) , ( 1 , {l}_{1} , … , {l}_{n} ) ) ,$$

where t₀, . . . , tₘ and v₁, . . . , vₙ denote the thread and value shapes, respectively, and d₀, . . . , dₘ and l₁, . . . , lₙ denote the corresponding thread and value strides.

Thus, the layout m can be given as:

$$m = ( ( {t}_{0} , … , {t}_{m} ) , ( L / K , {v}_{1} , … , {v}_{n} ) ) : ( ( {d}_{0} , … , {d}_{m} ) , ( 1 , {l}_{1} , … , {l}_{n} ) ) ∘ {f}^{- 1} .$$

Here, d₀, . . . , dₘ and l₁, . . . , lₙ are free strides. One may apply this process for all copy operations and verify the satisfiability by comparing the known strides of the candidate layouts. If the shared memory layouts are satisfiable, one may materialize the unknown strides and synthesize a unified shared memory layout that meets all the alignment requirements, as described in Section 5.2.

### REFERENCES

[1] Tom Brown, Benjamin Mann, Nick Ryder, Melanie Subbiah, Jared D Kaplan, Prafulla Dhariwal, Arvind Neelakantan, Pranav Shyam, Girish Sastry, Amanda Askell, Sandhini Agarwal, Ariel Herbert-Voss, Gretchen Krueger, Tom Henighan, Rewon Child, Aditya Ramesh, Daniel Ziegler, Jeffrey Wu, Clemens Winter, Chris Hesse, Mark Chen, Eric Sigler, Mateusz Litwin, Scott Gray, Benjamin Chess, Jack Clark, Christopher Berner, Sam McCandlish, Alec Radford, Ilya Sutskever, and Dario Amodei. 2020. Language Models are Few-Shot Learners. In Advances in Neural Information Processing Systems, H. Larochelle, M. Ranzato, R. Hadsell, M. F. Balcan, and H. Lin (Eds.), Vol. 33. Curran Associates, Inc., 1877-1901.
[2] Tianqi Chen, Thierry Moreau, Ziheng Jiang, Lianmin Zheng, Eddie Q. Yan, Haichen Shen, Meghan Cowan, Leyuan Wang, Yuwei Hu, Luis Ceze, Carlos Guestrin, and Arvind Krishnamurthy. 2018. TVM: An Automated End-to-End Optimizing Compiler for Deep Learning. In USENIX Symposium on Operating Systems Design and Implementation.
[3] Tri Dao, Daniel Y. Fu, Stefano Ermon, Atri Rudra, and Christopher Ré. 2022. FlashAttention: Fast and Memory-Efficient Exact Attention with IO-Awareness. In Advances in Neural Information Processing Systems.
[4] Jack W Davidson and Sanjay Jinturkar. 1994. Memory access coalescing: A technique for eliminating redundant memory accesses. Acm Sigplan Notices 29, 6 (1994), 186-195.
[5] DeepSeek-Al, Aixin Liu, Bei Feng, Bing Xue, Bingxuan Wang, Bochao Wu, Chengda Lu, Chenggang Zhao, Chengqi Deng, Chenyu Zhang, Chong Ruan, Damai Dai, Daya Guo, Dejian Yang, Deli Chen, Dongjie Ji, Erhang Li, Fangyun Lin, Fucong Dai, Fuli Luo, Guangbo Hao, Guanting Chen, Guowei Li, H. Zhang, Han Bao, Hanwei Xu, Haocheng Wang, Haowei Zhang, Honghui Ding, Huajian Xin, Huazuo Gao, Hui Li, Hui Qu, J. L. Cai, Jian Liang, Jianzhong Guo, Jiaqi Ni, Jiashi Li, Jiawei Wang, Jin Chen, Jingchang Chen, Jingyang Yuan, Junjie Qiu, Junlong Li, Junxiao Song, Kai Dong, Kai Hu, Kaige Gao, Kang Guan, Kexin Huang, Kuai Yu, Lean Wang, Lecong Zhang, Lei Xu, Leyi Xia, Liang Zhao, LitongWang, Liyue Zhang, Meng Li, MiaojunWang, Mingchuan Zhang, Minghua Zhang, Minghui Tang, Mingming Li, Ning Tian, Panpan Huang, Peiyi Wang, Peng Zhang, Qiancheng Wang, Qihao Zhu, Qinyu Chen, Qiushi Du, R. J. Chen, R. L. Jin, Ruiqi Ge, Ruisong Zhang, Ruizhe Pan, RunjiWang, Runxin Xu, Ruoyu Zhang, Ruyi Chen, S. S. Li, Shanghao Lu, Shangyan Zhou, Shanhuang Chen, Shaoqing Wu, Shengfeng Ye, Shengfeng Ye, Shirong Ma, Shiyu Wang, Shuang Zhou, Shuiping Yu, Shunfeng Zhou, Shuting Pan, T. Wang, Tao Yun, Tian Pei, Tianyu Sun, W. L. Xiao, Wangding Zeng, Wanjia Zhao, Wei An,Wen Liu,Wenfeng Liang,Wenjun Gao,Wenqin Yu,Wentao Zhang, X. Q. Li, Xiangyue Jin, Xianzu Wang, Xiao Bi, Xiaodong Liu, Xiaohan Wang, Xiaojin Shen, Xiaokang Chen, Xiaokang Zhang, Xiaosha Chen, Xiaotao Nie, Xiaowen Sun, Xiaoxiang Wang, Xin Cheng, Xin Liu, Xin Xie, Xingchao Liu, Xingkai Yu, Xinnan Song, Xinxia Shan, Xinyi Zhou, Xinyu Yang, Xinyuan Li, Xuecheng Su, Xuheng Lin, Y. K. Li, Y. Q. Wang, Y. X. Wei, Y. X. Zhu, Yang Zhang, Yanhong Xu, Yanhong Xu, Yanping Huang, Yao Li, Yao Zhao, Yaofeng Sun, Yaohui Li, Yaohui Wang, Yi Yu, Yi Zheng, Yichao Zhang, Yifan Shi, Yiliang Xiong, Ying He, Ying Tang, Yishi Piao, Yisong Wang, Yixuan Tan, Yiyang Ma, Yiyuan Liu, Yongqiang Guo, Yu Wu, Yuan Ou, Yuchen Zhu, Yuduan Wang, Yue Gong, Yuheng Zou, Yujia He, Yukun Zha, Yunfan Xiong, Yunxian Ma, Yuting Yan, Yuxiang Luo, Yuxiang You, Yuxuan Liu, Yuyang Zhou, Z. F. Wu, Z. Z. Ren, Zehui Ren, Zhangli Sha, Zhe Fu, Zhean Xu, Zhen Huang, Zhen Zhang, Zhenda Xie, Zhengyan Zhang, Zhewen Hao, Zhibin Gou, Zhicheng Ma, Zhigang Yan, Zhihong Shao, Zhipeng Xu, Zhiyu Wu, Zhongyu Zhang, Zhuoshu Li, Zihui Gu, Zijia Zhu, Zijun Liu, Zilin Li, Ziwei Xie, Ziyang Song, Ziyi Gao, and Zizheng Pan. 2025. DeepSeek-V3 Technical Report. arXiv:2412.19437 [cs.CL] https://arxiv.org/abs/2412.19437
[6] Yaoyao Ding, Cody Hao Yu, Bojian Zheng, Yizhi Liu, Yida Wang, and Gennady Pekhimenko. 2023. Hidet: Task-Mapping Programming Paradigm for Deep Learning Tensor Programs. In Proceedings of the 28^{th} ACM International Conference on Architectural Support for Programming Languages and Operating Systems, Volume 2 (Vancouver, BC, Canada) (ASPLOS 2023). Association for Computing Machinery, New York, NY, USA, 370-384. https://doi.org/10.1145/3575693.3575702
[7] Siyuan Feng, Bohan Hou, Hongyi Jin,Wuwei Lin, Junru Shao, Ruihang Lai, Zihao Ye, Lianmin Zheng, Cody Hao Yu, Yong Yu, and Tianqi Chen. 2022. TensorlR: An Abstraction for Automatic Tensorized Program Optimization. arXiv:2207.04296 [cs.LG]
[8] Elias Frantar and Dan Alistarh. 2024. Marlin: a fast 4-bit inference kernel for medium batchsizes. https://github.com/IST-DASLab/marlin.
[9] Elias Frantar, Saleh Ashkboos, Torsten Hoefler, and Dan Alistarh. 2023. GPTQ: Accurate Post-Training Quantization for Generative Pre-trained Transformers. arXiv:2210.17323 [cs.LG]
[10] Ronald Garcia and Matteo Cimini. 2015. Principal Type Schemes for Gradual Programs. In Proceedings of the 42nd Annual ACM SIGPLANSIGACT Symposium on Principles of Programming Languages (Mumbai, India) (POPL '15). Association for Computing Machinery, New York, NY, USA, 303-315. https://doi.org/10.1145/2676726.2676992
[11] Bastian Hagedorn, Bin Fan, Hanfeng Chen, Cris Cecka, Michael Garland, and Vinod Grover. 2023. Graphene: An IR for Optimized Tensor Computations on GPUs. In Proceedings of the 28th ACM International Conference on Architectural Support for Programming Languages and Operating Systems, Volume 3 (Vancouver, BC, Canada) (ASPLOS 2023). Association for Computing Machinery, New York, NY, USA, 302-313. https://doi.org/10.1145/3582016.3582018
[12] Kaiming He, Xiangyu Zhang, Shaoqing Ren, and Jian Sun. 2016. Deep Residual Learning for Image Recognition. In Proceedings of the IEEE Conference on Computer Vision and Pattern Recognition (CVPR).
[13] Ke Hong, Guohao Dai, Jiaming Xu, Qiuli Mao, Xiuhong Li, Jun Liu, kangdi chen, Yuhan Dong, and Yu Wang. 2024. FlashDecoding++: Faster Large Language Model Inference with Asynchronization, Flat GEMM Optimization, and Heuristics. In Proceedings of Machine Learning and Systems, P. Gibbons, G. Pekhimenko, and C. De Sa (Eds.), Vol. 6. 148-161. https://proceedings.mlsys.org/paper_files/paper/2024/file/321 b1dabcd2be188d796c21 b733e 8c7-Paper-Conference.pdf
[14] Guyue Huang, Yang Bai, Liu Liu, Yuke Wang, Bei Yu, Yufei Ding, and Yuan Xie. 2023. ALCOP: Automatic Load-Compute Pipelining in Deep Learning Compiler for Al-GPUs. In Proceedings of Machine Learning and Systems, D. Song, M. Carbin, and T. Chen (Eds.), Vol. 5. Curan, 680-694. https://proceedings.mlsys.org/paper_files/paper/2023/file/d6cde2c1b161daa31be560d062cf 2251-Paper-mlsys2023.pdf
[15] Qihang Huang, Zhiyi Huang, Paul Werstein, and Martin Purvis. 2008. GPU as a General Purpose Computing Resource. In 2008 Ninth International Conference on Parallel and Distributed Computing, Applications and Technologies. 151-158. https://doi.org/10.1109/PDCAT.2008.38
[16] Norm Jouppi, George Kurian, Sheng Li, Peter Ma, Rahul Nagarajan, Lifeng Nai, Nishant Patil, Suvinay Subramanian, Andy Swing, Brian Towles, Clifford Young, Xiang Zhou, Zongwei Zhou, and David A Patterson. 2023. TPU v4: An Optically Reconfigurable Supercomputer for Machine Learning with Hardware Support for Embeddings. In Proceedings of the 50th Annual International Symposium on Computer Architecture (Orlando, FL, USA) (ISCA '23). Association for Computing Machinery, New York, NY, USA, Article 82, 14 pages. https://doi.org/10.1145/3579371.3589350
[17] Woosuk Kwon, Zhuohan Li, Siyuan Zhuang, Ying Sheng, Lianmin Zheng, Cody Hao Yu, Joseph Gonzalez, Hao Zhang, and Ion Stoica. 2023. Efficient Memory Management for Large Language Model Serving with PagedAttention. In Proceedings of the 29th Symposium on Operating Systems Principles (, Koblenz, Germany,) (SOSP '23). Association for Computing Machinery, New York, NY, USA, 611-626. https://doi.org/10.1145/3600006.3613165
[18] Ji Lin, Jiaming Tang, Haotian Tang, Shang Yang, Xingyu Dang, Chuang Gan, and Song Han. 2023. AWQ: Activation-aware Weight Quantization for LLM Compression and Acceleration. arXiv:2306.00978 [cs.CL]
[19] Yujun Lin, Haotian Tang, Shang Yang, Zhekai Zhang, Guangxuan Xiao, Chuang Gan, and Song Han. 2024. QServe: W4A8KV4 Quantization and System Co-design for Efficient LLM Serving. arXiv:2405.04532 [cs.CL] https://arxiv.org/abs/2405.04532
[20] Eric Mahurin. 2023. QualocmmR Hexagon™ NPU. In 2023 IEEE Hot Chips 35 Symposium (HCS). 1-19. https://doi.org/10.1109/HCS59251.2023.10254715
[21] Stefano Markidis, Steven Wei Der Chien, Erwin Laure, Ivy Bo Peng, and Jeffrey S. Vetter. 2018. NVIDIA Tensor Core Programmability, Performance & Precision. In 2018 IEEE International Parallel and Distributed Processing Symposium Workshops (IPDPSW). IEEE Computer Society, Los Alamitos, CA, USA, 522-531. https://doi.org/10.1109/IPDPSW.2018.00091
[22] John Nickolls and William J. Dally. 2010. The GPU Computing Era. IEEE Micro 30, 2 (2010), 56-69. https://doi.org/10.1109/MM.2010.41
[23] NVIDIA. [n. d.]. cuBLAS. https://docs.nvidia.com/cuda/cublas/
[24] NVIDIA. 2024. CUTLASS—CuTe documentation. https://github.com/NVIDIA/cutlass/tree/main/media/docs/cute
[25] NVIDIA. 2024. TensorRT-LLM.
[26] Phitchaya Mangpo Phothilimthana, Archibald Samuel Elliott, An Wang, Abhinav Jangda, Bastian Hagedorn, Henrik Barthels, Samuel J. Kaufman, Vinod Grover, Emina Torlak, and Rastislav Bodik. 2019. Swizzle Inventor: Data Movement Synthesis for GPU Kernels. In Proceedings of the Twenty-Fourth International Conference on Architectural Support for Programming Languages and Operating Systems (Providence, RI, USA)
(ASPLOS '19). Association for Computing Machinery, New York, NY, USA, 65-78. https://doi.org/10.1145/3297858.3304059
[27] Jonathan Ragan-Kelley, Connelly Barnes, Andrew Adams, Sylvain Paris, Frédo Durand, and Saman Amarasinghe. 2013. Halide: A Language and Compiler for Optimizing Parallelism, Locality, and Recomputation in Image Processing Pipelines. SIGPLAN Not. 48, 6 (jun 2013), 519-530. https://doi.org/10.1145/2499370.2462176
[28] Bita Darvish Rouhani, Ritchie Zhao, Ankit More, Mathew Hall, Alireza Khodamoradi, Summer Deng, Dhruv Choudhary, Marius Cornea, Eric Dellinger, Kristof Denolf, Stosic Dusan, Venmugil Elango, Maximilian Golub, Alexander Heinecke, Phil James-Roxby, Dharmesh Jani, Gaurav Kolhe, Martin Langhammer, Ada Li, Levi Melnick, Maral Mesmakhosroshahi, Andres Rodriguez, Michael Schulte, Rasoul Shafipour, Lei Shao, Michael Siu, Pradeep Dubey, Paulius Micikevicius, Maxim Naumov, Colin Verrilli, Ralph Wittig, Doug Burger, and Eric Chung. 2023. Microscaling Data Formats for Deep Learning. arXiv:2310.10537 [cs.LG] https://arxiv.org/abs/2310.10537
[29] Noam Shazeer, Azalia Mirhoseini, Krzysztof Maziarz, Andy Davis, Quoc Le, Geoffrey Hinton, and Jeff Dean. 2017. Outrageously Large Neural Networks: The Sparsely-Gated Mixture-of-Experts Layer. arXiv:1701.06538 [cs.LG] https://arxiv.org/abs/1701.06538
[30] Vijay Thakkar, Pradeep Ramani, Cris Cecka, Aniket Shivam, Honghao Lu, Ethan Yan, Jack Kosaian, Mark Hoemmen, Haicheng Wu, Andrew Kerr, Matt Nicely, Duane Merrill, Dustyn Blasig, Fengqi Qiao, Piotr Majcher, Paul Springer, Markus Hohnerbach, Jin Wang, and Manish Gupta. 2024. CUTLASS.
[31] Philippe Tillet, H. T. Kung, and David Cox. 2019. Triton: An Intermediate Language and Compiler for Tiled Neural Network Computations. In Proceedings of the 3rd ACM SIGPLAN International Workshop on Machine Learning and Programming Languages (Phoenix, AZ, USA) (MAPL 2019). Association for Computing Machinery, New York, NY, USA, 10-19. https://doi.org/10.1145/3315508.3329973
[32] Hugo Touvron, Thibaut Lavril, Gautier Izacard, Xavier Martinet, Marie-Anne Lachaux, Timothée Lacroix, Baptiste Rozière, Naman Goyal, Eric Hambro, Faisal Azhar, et al. 2023. Llama: Open and efficient foundation language models. arXiv preprint arXiv:2302.13971 (2023).
[33] Andreas Tretter, Georgia Giannopoulou, Matthias Baer, and Lothar Thiele. 2017. Minimising access conflicts on shared multi-bank memory. ACM Transactions on Embedded Computing Systems (TECS) 16, 5s (2017), 1-20.
[34] Hongyu Wang, Shuming Ma, Li Dong, Shaohan Huang, Huaijie Wang, Lingxiao Ma, Fan Yang, Ruiping Wang, Yi Wu, and Furu Wei. 2023. BitNet: Scaling 1-bit Transformers for Large Language Models. arXiv:2310.11453 [cs.CL] https://arxiv.org/abs/2310.11453
[35] Lei Wang, Lingxiao Ma, Shijie Cao, Quanlu Zhang, Jilong Xue, Yining Shi, Ningxin Zheng, Ziming Miao, Fan Yang, Ting Cao, Yuqing Yang, and Mao Yang. 2024. Ladder: Enabling Efficient Low-Precision Deep Learning Computing through Hardware-aware Tensor Transformation. In OSDI 2024.
[36] Haojun Xia, Zhen Zheng, Xiaoxia Wu, Shiyang Chen, Zhewei Yao, Stephen Youn, Arash Bakhtiari, Michael Wyatt, Donglin Zhuang, Zhongzhu Zhou, Olatunji Ruwase, Yuxiong He, and Shuaiwen Leon Song. 2024. Quant-LLM: Accelerating the Serving of Large Language Models via FP6-Centric Algorithm-System Co-Design on Modern GPUs. In 2024 USENIX Annual Technical Conference (USENIX ATC 24). USENIX Association, Santa Clara, CA, 699-713. https://www.usenix.org/conference/atc24/presentation/xia
[37] Guangxuan Xiao, Ji Lin, Mickael Seznec, HaoWu, Julien Demouth, and Song Han. 2023. SmoothQuant: accurate and efficient post-training quantization for large language models. In Proceedings of the 40^{th} International Conference on Machine Learning (Honolulu, Hawaii, USA) (ICML'23). JMLR.org, Article 1585, 13 pages.
[38] Da Yan, Wei Wang, and Xiaowen Chu. 2020. Demystifying Tensor Cores to Optimize Half-Precision Matrix Multiply. In 2020 IEEE International Parallel and Distributed Processing Symposium (IPDPS). 634-643. https://doi.org/10.1109/IPDPS47924.2020.00071
[39] Zihao Ye, Lequn Chen, Ruihang Lai, Yilong Zhao, Size Zheng, Junru Shao, Bohan Hou, Hongyi Jin, Yifei Zuo, Liangsheng Yin, Tianqi Chen, and Luis Ceze. 2024. Flashlnfer: Kernel Library for LLM Serving. https://github.com/flashinfer-ai/flashinfer.
[40] Zihao Ye, Ruihang Lai, Junru Shao, Tianqi Chen, and Luis Ceze. 2023. SparseTIR: Composable Abstractions for Sparse Compilation in Deep Learning. In Proceedings of the 28th ACM International Conference on Architectural Support for Programming Languages and Operating Systems, Volume 3 (Vancouver, BC, Canada) (ASPLOS 2023). Association for Computing Machinery, New York, NY, USA, 660-678. https://doi.org/10.1145/3582016.3582047
[41] Ekim Yurtsever, Jacob Lambert, Alexander Carballo, and Kazuya Takeda. 2020. A survey of autonomous driving: Common practices and emerging technologies. IEEE access 8 (2020), 58443-58469.
[42] Lianmin Zheng, Chengfan Jia, Minmin Sun, Zhao Wu, Cody Hao Yu, Ameer Haj-Ali, Yida Wang, Jun Yang, Danyang Zhuo, Koushik Sen, Joseph E. Gonzalez, and Ion Stoica. 2020. Ansor: Generating High-Performance Tensor Programs for Deep Learning. In Proceedings of the 14th USENIX Conference on Operating Systems Design and Implementation (OSDI'20). USENIX Association, USA, Article 49, 17 pages.
[43] Size Zheng, Renze Chen, Anjiang Wei, Yicheng Jin, Qin Han, Liqiang Lu, Bingyang Wu, Xiuhong Li, Shengen Yan, and Yun Liang. 2022. AMOS: enabling automatic mapping for tensor computations on spatial accelerators with hardware abstraction. In ISCA '22: The 49th Annual International Symposium on Computer Architecture, New York, New York, USA, Jun. 18-22, 2022, Valentina Salapura, Mohamed Zahran, Fred Chong, and Lingjia Tang (Eds.). ACM, 874-887. https://doi.org/10.1145/3470496.3527440
[44] Size Zheng, Yun Liang, Shuo Wang, Renze Chen, and Kaiwen Sheng. 2020. FlexTensor: An Automatic Schedule Exploration and Optimization Framework for Tensor Computation on Heterogeneous System. In Proceedings of the Twenty-Fifth International Conference on Architectural Support for Programming Languages and Operating Systems (Lausanne, Switzerland) (ASPLOS '20). Association for Computing Machinery, New York, NY, USA, 859-873. https://doi.org/10.1145/3373376.3378508

1. A method of compiling computer programs using machine learning compilers, the method comprising:
obtaining a first computer program written in a script with a defined programming language dialect for a particular machine learning compiler, the dialect representing computer programs of mathematical operations in machine learning applications;
defining a higher level intermediate representation (IR) that represents the first computer program written with the defined programming language dialect;
generating a second computer program represented in the higher level IR from the first computer program written in the defined programming language dialect;
deriving a plurality of new optimization passes based on the higher level IR that, when applied, the particular machine learning compiler optimizes the performance of executing computer programs in a target computing environment;
converting the second computer program represented in the higher level IR into a third computer program represented in one or more lower-level IRs that exist in the machine learning compiler;
applying a plurality of existing optimization passes to generate an optimized fourth computer program represented in the existing lower-level IR for the particular machine learning compiler; and
converting the optimized fourth computer program represented in the existing lower-level IR-to-machine instructions to be used in a machine learning application.

2. The method of claim 1, wherein the plurality of new optimization passes comprises instantiating an auto annotation operation.

3. The method of claim 1, wherein the plurality of new optimization passes comprises an instruction selection step.

4. The method of claim 1, wherein the plurality of new optimization passes comprises a bank conflict elimination operation.

5. The method of claim 1, wherein the plurality of new optimization passes comprises lowering a program represented in the higher level IR to generate the third computer program in the one or more lower level IRs existing in the machine learning compiler.

6. The method of claim 1, wherein the machine learning compiler is a Hidet compiler and the plurality of existing optimization passes comprise optimization passes existing in the Hidet compiler.

7. The method of claim 1, further comprising providing the machine instructions to the machine learning application for execution.

8. The method of claim 1, wherein the defined programming language dialect is the Hexcute dialect.

9. The method of claim 1, wherein the mathematical operations in machine learning applications comprise matrix multiplication, convolution, attention, activation functions, normalization, and/or pooling.

10. A non-transitory computer readable medium storing computer-executable instructions for compiling computer programs using machine learning compilers, the instructions comprising instructions for:
obtaining a first computer program written in a script with a defined programming language dialect for a particular machine learning compiler, the dialect representing computer programs of mathematical operations in machine learning applications;
defining a higher level intermediate representation (IR) that represents the first computer program written with the defined programming language dialect;
generating a second computer program represented in the higher level IR from the first computer program written in the defined programming language dialect;
deriving a plurality of new optimization passes based on the higher level IR that, when applied, the particular machine learning compiler optimizes the performance of executing computer programs in a target computing environment;
converting the second computer program represented in the higher level IR into a third computer program represented in one or more lower-level IRs that exist in the machine learning compiler;
applying a plurality of existing optimization passes to generate an optimized fourth computer program represented in the existing lower-level IR for the particular machine learning compiler; and
converting the optimized fourth computer program represented in the existing lower-level IR-to-machine instructions to be used in a machine learning application.

11. The computer readable medium of claim 10, wherein the plurality of new optimization passes comprises instantiating an auto annotation operation.

12. The computer readable medium of claim 10, wherein the plurality of new optimization passes comprises an instruction selection step.

13. The computer readable medium of claim 10, wherein the plurality of new optimization passes comprises a bank conflict elimination operation.

14. The computer readable medium of claim 10, wherein the plurality of new optimization passes comprises lowering a program represented in the higher level IR to generate the third computer program in the one or more lower level IRs existing in the machine learning compiler.

15. The computer readable medium of claim 10, wherein the machine learning compiler is a Hidet compiler and the plurality of existing optimization passes comprise optimization passes existing in the Hidet compiler.

16. The computer readable medium of claim 10, further comprising instructions for providing the machine instructions to the machine learning application for execution.

17. The computer readable medium of claim 10, wherein the defined programming language dialect is the Hexcute dialect.

18. The computer readable medium of claim 10, wherein the mathematical operations in machine learning applications comprise matrix multiplication, convolution, attention, activation functions, normalization, and/or pooling.

19. A computer system for compiling computer programs using machine learning compilers comprising:
a processor; and
memory, the memory storing computer-executable instructions that, when executed by the processor, cause the computer system to perform operations comprising:
obtaining a first computer program written in a script with a defined programming language dialect for a particular machine learning compiler, the dialect representing computer programs of mathematical operations in machine learning applications;
defining a higher level intermediate representation (IR) that represents the first computer program written with the defined programming language dialect;
generating a second computer program represented in the higher level IR from the first computer program written in the defined programming language dialect;
deriving a plurality of new optimization passes based on the higher level IR that, when applied, the particular machine learning compiler optimizes the performance of executing computer programs in a target computing environment;
converting the second computer program represented in the higher level IR into a third computer program represented in one or more lower-level IRs that exist in the machine learning compiler;
applying a plurality of existing optimization passes to generate an optimized fourth computer program represented in the existing lower-level IR for the particular machine learning compiler; and
converting the optimized fourth computer program represented in the existing lower-level IR-to-machine instructions to be used in a machine learning application.
